(19) United States
(12) Patent Application Publication
(10) Pub. No.: US 2025/0124879 A1
(43) Pub. Date: Apr. 17, 2025

(54) DISPLAY PANEL, DISPLAY APPARATUS, AND METHOD FOR DRIVING DISPLAY PANEL

(71) Applicant: BOE TECHNOLOGY GROUP CO., LTD., Beijing (CN)

(72) Inventors: Guangliang SHANG, Beijing (CN); Jianchao ZHU, Beijing (CN); Jiangnan LU, Beijing (CN); Yu FENG, Beijing (CN); Rui XU, Beijing (CN); Xing YAO, Beijing (CN)

(21) Appl. No.: 18/687,988

(22) PCT Filed: Nov. 24, 2022
(86) PCT No.: PCT/CN2022/133854

§ 371 Date: Feb. 29, 2024

(51) Int. Cl. G09G 3/3266

(52) U.S. Cl. CPC G09G 3/3266; G09G 2310/0286; G09G 2310/08; G09G 2330/021

(57) ABSTRACT

Provided are a display panel, a display apparatus and a method for driving the display panel. The display panel includes: multiple gate lines; and multiple shift register units, a target shift register unit of the shift register units includes: a frame trigger selecting circuit and a gate driving circuit; the frame trigger selecting circuit is coupled to a frame trigger input terminal and frame starting signal terminals corresponding to N cascade groups, and outputs, in response to an n^{th} turn-on signal of N turn-on signals corresponding to an n^{th} cascade group, a starting signal input to the frame trigger input terminal to a frame starting signal terminal corresponding to the n^{th} cascade group; 1≤n≤N, and n is an integer; the n^{th} cascade group scans the gate lines coupled thereto line by line after the frame starting signal terminal corresponding thereto receives the starting signal.

### TECHNICAL FIELD

The present disclosure relates to the field of display technologies, and in particular, to a display panel, a display apparatus, and a method for driving the display panel.

### BACKGROUND

A display panel, such as an Organic Light-Emitting Diode (OLED) display panel, and a Quantum Dot Light-Emitting Diode (QLED) display panel, generally includes a plurality of pixel units. Each pixel unit may include a plurality of sub-pixels with different colors. By controlling brightness of light emitted by the sub-pixels with different colors, these colors can be mixed to obtain colors desired to be displayed, and a color image can be displayed.

### SUMMARY

An embodiment of the present disclosure provides a display panel, including:
a plurality of gate lines; and
a plurality of shift register units, where a target shift register unit of the plurality of shift register units includes: a frame trigger selecting circuit and a gate driving circuit; the gate driving circuit includes a plurality of first shift registers, a driving output terminal of each first shift register is coupled to at least one of the gate lines, the plurality of first shift registers are divided into N cascade groups, the first shift registers in each cascade group are cascaded, and different cascade groups are coupled to different frame starting signal terminals; N is an integer greater than 1, where
the frame trigger selecting circuit is coupled to a frame trigger input terminal and the frame starting signal terminals corresponding to the N cascade groups; the frame trigger selecting circuit is configured to output, in response to an n^{th} turn-on signal of N turn-on signals corresponds to an n^{th} cascade group of the N cascade groups, a starting signal input to the frame trigger input terminal to a frame starting signal terminal corresponding to the n^{th} cascade group; n is more than or equal to 1 and less than or equal to N, and n is an integer; and
the n^{th} cascade group is configure to scan the gate lines coupled thereto line by line after the frame starting signal terminal corresponding thereto receives the starting signal.

In some possible implementations provided by the present disclosure, the frame trigger selecting circuit includes: N frame trigger selecting sub-circuits, the N frame trigger selecting sub-circuits corresponding to the N cascade groups and the N turn-on signals one by one;
input terminals of the N frame trigger selecting sub-circuits are coupled to the frame trigger input terminal, and an output terminal of an n^{th} frame trigger selecting sub-circuit of the N frame trigger selecting sub-circuits is coupled to the frame starting signal terminal corresponding to the n^{th} cascade group; and
the n^{th} frame trigger selecting sub-circuit is configured to output, in response to the n^{th} turn-on signal, the starting signal input to the frame trigger input terminal to the frame starting signal terminal corresponding to the n^{th} cascade group.

In some possible implementations provided by the present disclosure, the n^{th} frame trigger selecting sub-circuit includes: M trigger transistors, a first electrode of a first trigger transistor of the M trigger transistors is coupled to the frame trigger input terminal, a second electrode of a former one of every two adjacent trigger transistors is coupled to a first electrode of a latter one of the two adjacent trigger transistors, and a second electrode of a last trigger transistor of the M trigger transistors is coupled to the frame starting signal terminal corresponding to the n^{th} cascade group;
the n turn-on signal includes M level signals, and a gate of an m^{th} trigger transistor of the M trigger transistors is configured to receive an m^{th} level signal of the M level signals; and
M is an integer greater than 0, m is greater than or equal to 1 and less than or equal to M, and m is an integer.

In some possible implementations provided by the present disclosure, the trigger transistors in at least part of the frame trigger selecting sub-circuits are of different types;
the display panel further includes: M first turn-on signal lines, the m^{th} level signal is input through an m^{th} first turn-on signal line of the M first turn-on signal lines; and
the gate of the m^{th} trigger transistor in each frame trigger selecting sub-circuit is coupled to the m^{th} first turn-on signal line of the M first turn-on signal lines.

In some possible implementations provided by the present disclosure, the trigger transistors in all of the frame trigger selecting sub-circuits are of the same type; the display panel further includes: M signal line groups, each of the M signal line groups includes a second turn-on signal line and a third turn-on signal line, the second turn-on signal line and the third turn-on signal line in each signal line group simultaneously transmit signals with opposite phases;
the m^{th} trigger transistor in each frame trigger selecting sub-circuit corresponds to an m^{th} signal line group of the M signal line groups, and the gates of the m^{th} trigger transistors in part of the frame trigger selecting sub-circuits are coupled to the second turn-on signal line in the m^{th} signal line group, and the gates of the m^{th} trigger transistors in the rest of the frame trigger selecting sub-circuits are coupled to the third turn-on signal line in the m^{th} signal line group.

In some possible implementations provided by the present disclosure, the target shift register unit further includes: N noise reduction circuits, the N noise reduction circuits corresponding to the N frame trigger selecting sub-circuits and N noise reduction control signals one by one; and
an n^{th} noise reduction circuit of the N noise reduction circuits is configured to output, in response to an n^{th} noise reduction control signal of the N noise reduction control signals, a signal at a noise reduction reference signal terminal to the frame starting signal terminal corresponding to the n^{th} cascade group.

In some possible implementations provided by the present disclosure, the n^{th} noise reduction circuit includes: K noise reduction transistors, a first electrode of each of the K noise reduction transistors is coupled to the noise reduction reference signal terminal, and a second electrode of each of the K noise reduction transistors is coupled to the frame starting signal terminal;
an n^{th} noise reduction control signal includes K level signals, and the gate of a k^{th} noise reduction transistor of the K noise reduction transistors is configured to receive a k^{th} level signal of the K level signals; and
K is an integer greater than 0, k is greater than or equal to 1 and less than or equal to K, and k is an integer.

In some possible implementations provided by the present disclosure, the noise reduction transistors in at least part of the noise reduction circuits are different in type;
the display panel further includes: K noise reduction control signal lines; the k^{th} level signal is input through a k^{th} noise reduction control signal line of the K noise reduction control signal lines; and
the gate of the k^{th} noise reduction transistor in each noise reduction circuit is coupled to the k^{th} noise reduction control signal line of the K noise reduction control signal lines.

In some possible implementations provided by the present disclosure, K is equal to M, and the m^{th} first turn-on signal line and k^{th} noise reduction control signal line simultaneously transmit signals having the same or opposite phases.

In some possible implementations provided by the present disclosure, the plurality of gate lines includes a plurality of first gate lines; the target shift register unit includes a first target shift register unit; a driving output terminal of each first shift register in the first target shift register unit is coupled to at least one of the first gate lines; and
the display panel comprises a pixel circuit, the pixel circuit includes a turn-on control transistor; one of the first gate lines is coupled to a gate of the turn-on control transistor, and is configured to drive the turn-on control transistor.

In some possible implementations provided by the present disclosure, the plurality of gate lines includes a plurality of second gate lines; the target shift register unit includes a second target shift register unit; a driving output terminal of each first shift register in the second target shift register unit is coupled to at least one of the second gate lines; and
the display panel includes a pixel circuit, the pixel circuit includes a data writing transistor; one of the second gate lines is coupled to a gate of the data writing transistor, and configured to drive the data writing transistor.

In some possible implementations provided by the present disclosure, each first shift register in the target shift register unit includes a left first shift register and a right first shift register coupled to the gate line at two sides of the gate line, respectively; and
the left first shift register and the right first shift register are configured to simultaneously drive the gate line coupled thereto.

In some possible implementations provided by the present disclosure, the display panel further includes: a plurality of light emission control signal lines;
the plurality of shift register units further include: a light emission control circuit; the light emission control circuit includes a plurality of second shift registers, and a driving output terminal of each second shift register is coupled to at least one of the light emission control signal lines; and
the display panel includes a pixel circuit; the pixel circuit includes a first light emission control transistor; the light emission control signal line is coupled to a gate of the first light emission control transistor, and is configured to drive the first light emission control transistor.

In some possible implementations provided by the present disclosure, the display panel further includes: a plurality of reset control signal lines;
the plurality of shift register units further include: a reset control circuit; the reset control circuit includes a plurality of third shift registers, and a driving output terminal of each third shift register is coupled to at least one of the reset control signal lines; and
the display panel includes a pixel circuit; the pixel circuit includes an anode reset transistor; the reset control signal line is coupled to a gate of the anode reset transistor and is configured to drive the anode reset transistor.

An embodiment of the present disclosure further provides a display apparatus including the display panel described above.

An embodiment of the present disclosure further provides a method for driving the display panel provided by the embodiments of the present disclosure, including:
in response to that a first driving mode is adopted, during a display frame, the N turn-on signals are sequentially applied to the frame trigger selecting circuit, then the N cascade groups respectively receive the starting signal through frame starting signal terminals corresponding thereto to control the cascade groups to operate in sequence and the shift registers in each cascade group scans the gate lines coupled thereto line by line, and the plurality of gate lines are scanned line by line; and
in response to that a second driving mode is adopted, during a display frame, a turn-on signal corresponding to a specified cascade group is applied to the frame trigger selecting circuit, then the specified cascade group receives the starting signal through a frame starting signal terminal corresponding thereto to control the shift registers in the specified cascade group to scan the gate lines coupled thereto line by line.

In some possible implementations provided by the present disclosure, the method further includes: in response to that the second driving mode is adopted,
a turn-off signal corresponding to each of the rest of the plurality of cascade groups except the specified cascade group is applied to the frame trigger selecting circuit.

### BRIEF DESCRIPTION OF DRAWINGS

FIG. 1 is a schematic diagram of a partial structure of a display panel according to an embodiment of the present disclosure;

FIG. 2 is a schematic diagram of a partial structure of a pixel circuit according to an embodiment of the present disclosure;

FIG. 3 is a schematic diagram of a partial structure of a display panel according to an embodiment of the present disclosure;

FIG. 4a is a schematic diagram of a partial structure of a display panel according to an embodiment of the present disclosure;

FIG. 4b is a schematic diagram of a partial structure of a display panel according to an embodiment of the present disclosure;

FIG. 5a is a schematic diagram of a partial structure of a display panel according to an embodiment of the present disclosure;

FIG. 5b is a schematic diagram of a partial structure of a display panel according to an embodiment of the present disclosure;

FIG. 6a is a schematic diagram of a partial structure of a first shift register according to an embodiment of the present disclosure;

FIG. 6b is a schematic diagram of a partial structure of a first shift register according to an embodiment of the present disclosure;

FIG. 7a is a schematic diagram of a partial structure of a display panel according to an embodiment of the present disclosure;

FIG. 7b is a timing diagram of some signals according to an embodiment of the present disclosure;

FIG. 7c is a flowchart of a method for driving a display panel according to an embodiment of the present disclosure;

FIG. 8a is a timing diagram of some signals according to an embodiment of the present disclosure;

FIG. 8b is a timing diagram of some signals according to an embodiment of the present disclosure;

FIG. 9a is a timing diagram of some signals according to an embodiment of the present disclosure;

FIG. 9b is a timing diagram of some signals according to an embodiment of the present disclosure;

FIG. 10 is a schematic diagram of a partial structure of a display panel according to an embodiment of the present disclosure;

FIG. 11 is a schematic diagram of a partial structure of a display panel according to an embodiment of the present disclosure;

FIG. 12 is a schematic diagram of a partial structure of a display panel according to an embodiment of the present disclosure.

### DETAIL DESCRIPTION OF EMBODIMENTS

To make the objects, technical solutions and advantages of the embodiments of the present disclosure more apparent, the technical solutions of the embodiments of the present disclosure will be clearly and completely described below with reference to the drawings of the embodiments of the present disclosure. It is to be understood that the described embodiments are only a few embodiments of the present disclosure, and not all embodiments. The embodiments and features of the embodiments in the present disclosure may be combined with each other without conflict. All other embodiments, which can be derived by those skilled in the art from the described embodiments of the present disclosure without creative effort, are within the protection scope of the present disclosure.

Unless defined otherwise, technical or scientific terms used herein shall have the ordinary meaning as understood by those skilled in the art to which the present disclosure belongs. The use of “first”, “second” and the like in the present disclosure is not intended to indicate any order, quantity, or importance, but rather is used to distinguish one element from another. The word “comprising/including” or “comprises/includes”, and the like, means that the element or item preceding the word comprises/includes the element or item listed after the word and its equivalent, but does not exclude other elements or items. The terms “connected/coupled”, “connecting/coupling”, and the like are not restricted to physical or mechanical connections, but may include electrical connections, whether direct or indirect.

It should be noted that sizes and shapes of various figures in the drawings are not to scale, but are merely intended to illustrate the present disclosure. Like reference numerals refer to like or similar elements or elements having like or similar functions throughout.

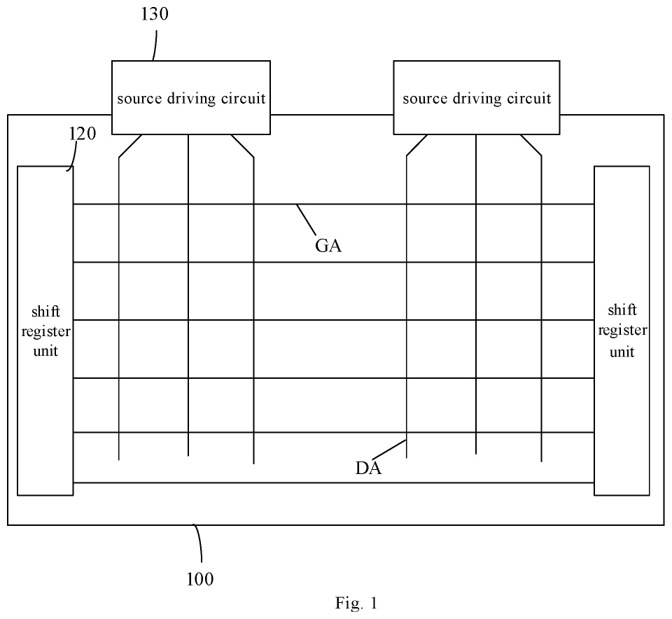

In some embodiments of the present disclosure, as shown in FIG. 1, a display panel 100 includes: a plurality of pixel units arranged in an array, a plurality of gate lines GA, a plurality of data lines DA, a plurality of shift register units 120 and a plurality of source driving circuits 130. Each pixel unit includes a plurality of sub-pixels. For example, the pixel unit may include a red sub-pixel, a green sub-pixel, and a blue sub-pixel, so that red, green, and blue may be mixed to implement color display. Alternatively, the pixel unit may include a red sub-pixel, a green sub-pixel, a blue sub-pixel, and a white sub-pixel, so that red, green, blue, and white may be mixed to implement color display. Certainly, in practical applications, the colors of light emitted by the sub-pixels in the pixel unit may be determined according to practical application environments, and is not limited herein.

In some implementations, the shift register units 120 are respectively coupled to the gate lines GA, and the source driving circuits 130 are respectively coupled to the data lines DA. When the display panel operates, control signals are input to the shift register units 120, so that the shift register units 120 output signals to the gate lines coupled thereto, so as to drive the gate lines. The source driving circuits 130 input data voltages to the data lines according to the display data, so as to charge the sub-pixels and input corresponding data voltages to the sub-pixels to display a picture.

In some implementations, the display panel may include two source driving circuits 130, one of the source driving circuits 130 may be connected to half of the data lines, and the other of the source driving circuits 130 may be connected to the other half of the data lines. Certainly, in practical applications, the display panel may include three, four, or more source driving circuits 130, which may be determined according to requirements of practical application environments, which is not limited in the present disclosure.

In some embodiments of the present disclosure, each column of sub-pixels may correspond to one of the data lines. Certainly, each column of sub-pixels may correspond to a plurality of data lines, which is not limited herein.

In some embodiments of the present disclosure, the plurality of gate lines may include: a plurality of first gate lines and a plurality of second gate lines. Alternatively, each row of sub-pixels may correspond to one of the first gate lines and one of the second gate lines. Certainly, each row of sub-pixels may correspond to a plurality of first gate lines, and each row of sub-pixels may correspond to a plurality of second gate lines, which is not limited herein.

In some embodiments of the present disclosure, the display panel further includes: a plurality of light emission control signal lines and a plurality of reset control signal lines. Alternatively, each row of sub-pixels may correspond to one of the light emission control signal lines and one of the reset control signal lines. Certainly, each row of sub-pixels may alternatively correspond to a plurality of light emission control signal lines, and each row of sub-pixels may alternatively correspond to a plurality of reset control signal lines, which is not limited herein.

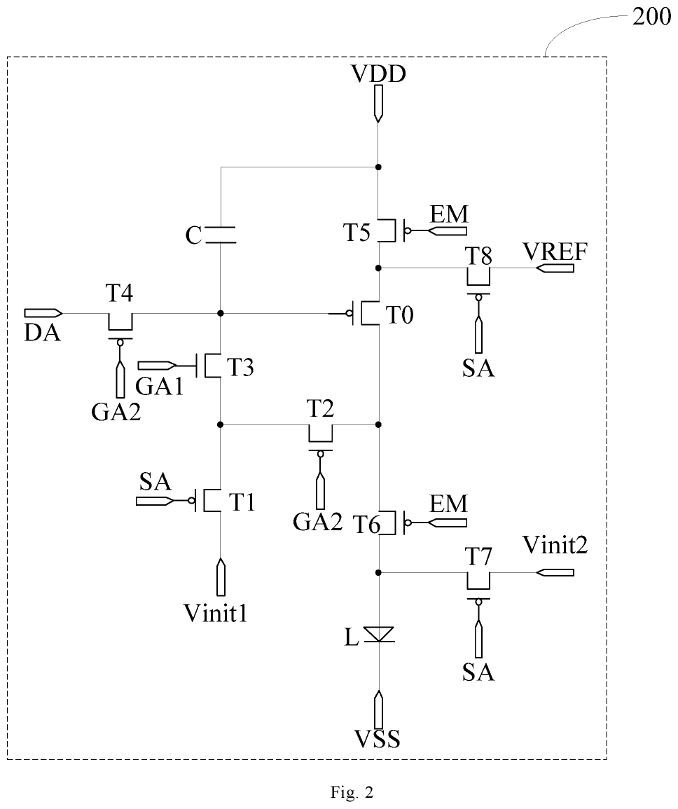

In some implementations, each sub-pixel may include a pixel circuit. Alternatively, as shown in FIG. 2, the pixel circuit 200 includes: a driving transistor T0, an initialization transistor T1, a compensation transistor T2, a turn-on control transistor T3, a data writing transistor T4, a first light emission control transistor T5, a second light emission control transistor T6, an anode reset transistor T7, a noise reduction transistor T8, a storage capacitor C, and a light emitting device L.

A gate of the initialization transistor T1 is coupled to a reset control signal line SA, so that the initialization transistor T1 is driven by a signal transmitted on the reset control signal line SA. A first electrode of the initialization transistor T1 is coupled to a first electrode of the compensation transistor T2, and a second electrode of the initialization transistor T1 is coupled to a first initialization voltage terminal Vinit1.

A gate of the compensation transistor T2 is coupled to a second gate line GA2, so that the compensation transistor T2 is driven by a signal transmitted on the second gate line GA2. A second electrode of the compensation transistor T2 is coupled to a second electrode of the driving transistor T0.

A gate of the turn-on control transistor T3 is coupled to a first gate line GA1, so that the turn-on control transistor T3 is driven by a signal transmitted on the first gate line GA1. A first electrode of the turn-on control transistor T3 is coupled to a gate of the driving transistor T0, and a second electrode of the turn-on control transistor T3 is coupled to the first electrode of the initialization transistor T1.

A gate of the data writing transistor T4 is coupled to the second gate line GA2, so that the data writing transistor T4 is driven by a signal transmitted on the second gate line GA2. A first electrode of the data writing transistor T4 is coupled to a data line DA, and a second electrode of the data writing transistor T4 is coupled to the gate of the driving transistor T0.

A gate of the first light emission control transistor T5 is coupled to a light emission control signal line EM, so that the first light emission control transistor T5 is driven by a signal transmitted on the light emission control signal line EM. A first electrode of the first light emission control transistor T5 is coupled to a first power terminal VDD, and a second electrode of the first light emission control transistor T5 is coupled to a first electrode of the driving transistor T0.

A gate of the second emission control transistor T6 is coupled to the light emission control signal line EM, so that the second emission control transistor T6 is driven by a signal transmitted on the light emission control signal line EM. A first electrode of the second light emission control transistor T6 is coupled to the second electrode of the driving transistor T0, and a second electrode of the second light emission control transistor T6 is coupled to an anode of the light emitting device L.

A gate of the anode reset transistor T7 is coupled to the reset control signal line SA, so that the anode reset transistor T7 is driven by the signal transmitted on the reset control signal line SA. A first electrode of the anode reset transistor T7 is coupled to the anode of the light emitting device L, and a second electrode of the anode reset transistor T7 is coupled to a second initial voltage terminal Vinit2.

A gate of the noise reduction transistor T8 is coupled to the reset control signal line SA, so that the noise reduction transistor T8 is driven by the signal transmitted on the reset control signal line SA. A first electrode of the noise reduction transistor T8 is coupled to the first electrode of the driving transistor T0.

A cathode of the light emitting device L is coupled to a second power terminal VSS.

A first electrode of the storage capacitor C is coupled to the first power terminal VDD, and a second electrode of the storage capacitor C is coupled to the gate of the driving transistor T0.

In some implementations, as shown in FIG. 2, the turn-on control transistor T3 may be an N-type transistor, and the driving transistor T0, the initialization transistor T1, the compensation transistor T2, the data writing transistor T4, the first light emission control transistor T5, the second light emission control transistor T6, the anode reset transistor T7, and the noise reduction transistor T8 may be P-type transistors. The N-type transistor is turned on under the control a high-level signal and turned off under the control of a low-level signal. The P-type transistor is turned on under the control of a low-level signal and turned off under the control of a high-level signal.

Since the light emitting diodes, such as Organic Light Emitting Diodes (OLEDs), Quantum Dot Light Emitting Diodes (QLEDs), have the advantages of self-luminescence, low power consumption, and the like, in specific implementations, the display panel may be an light emitting diode display panel, that is, the light emitting device is a light emitting diode. In some implementations, in a case where the display panel is an OLED display panel, the light emitting device may be an OLED. In a case where the display panel is a QLED display panel, the light emitting device may be a QLED.

In some embodiments of the present disclosure, a target shift register unit is specified in the plurality of shift register units. The target shift register unit includes: a frame trigger selecting circuit and a gate driving circuit. The gate driving circuit includes a plurality of first shift registers, a driving output terminal of each first shift register is coupled to at least one of the gate lines GA, the first shift registers are divided into N cascade groups, the first shift registers in a same cascade group are cascaded, and different cascade groups are coupled to different frame starting signal terminals. An n^{th} cascade group of the N cascade groups is configured for scanning the gate lines coupled to the n^{th} cascade group line by line after receiving a starting signal at a frame starting signal terminal corresponding thereto.

In some implementations, N may be equal to two, and thus the target shift register unit includes two cascade groups. Alternatively, N may be equal to three, and thus the target shift register unit includes three cascade groups. Alternatively, N may be equal to four, and thus the target shift register unit includes four cascade groups. Alternatively, N may be equal to eight, and thus the target shift register unit includes eight cascade groups. Certainly, the specific value of N may be determined according to the requirements of the actual application environments, and is not limited herein.

The frame trigger selecting circuit is coupled to a frame trigger input terminal and the frame starting signal terminals corresponding to the N cascade groups. The frame trigger selecting circuit is configured to output, in response to an n^{th} turn-on signal of N turn-on signals corresponding to an n^{th} cascade group in the plurality of cascade groups, a starting signal input to the frame trigger input terminal to a frame starting signal terminal corresponding to the n^{th} cascade group. N is more than or equal to 1 and less than or equal to N, and n is an integer.

In the embodiment of the present disclosure, through the mutual cooperation of the frame trigger selecting circuit and the gate driving circuit, not only data of the whole pixel region of the display panel can be refreshed row by row, but also a partial region of the display panel can be selected for refreshing data. Therefore, when data of a partial area of the display picture is refreshed, the display panel refreshes only the selected partial region of the display panel, so that the partial region is refreshed with a high-frequency, and other regions do not be refreshed, so that other regions are refreshed wi^{th} a low-frequency, and the power consumption for driving can be reduced to the maximum extent.

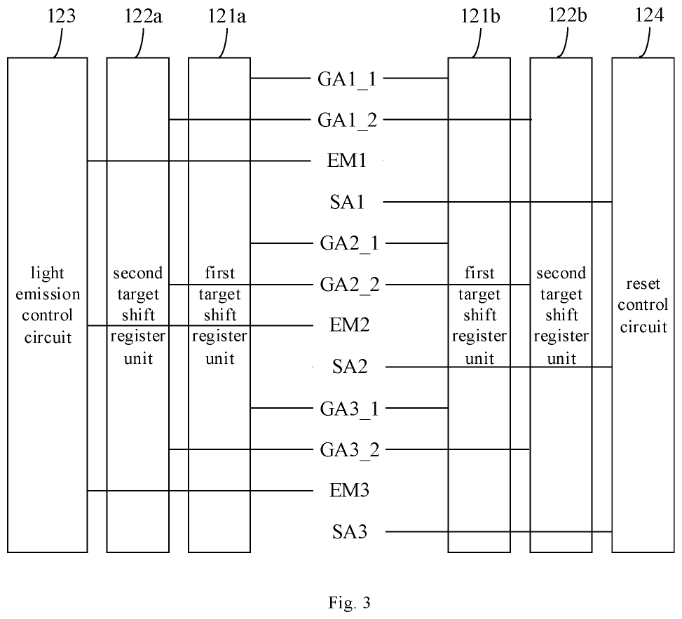

In some embodiments of the present disclosure, as shown in FIG. 3, the target shift register units may include first target shift register units (e.g., 121a, 121b); a driving output terminal of the first shift register in the first target shift register unit is coupled to at least one of the first gate lines (e.g., GA1_1, GA2_1, GA3_1). In some implementations, the driving output terminal of the first shift register in the first target shift register unit is coupled to one of the first gate lines.

In some implementations, for the first target shift register unit, when an active level of a signal at the frame starting signal terminal is a high level, an active level of a signal output by the first shift register is a high level, so that the transistor connected to the first gate line is turned on. In this case, an inactive level of the signal at the frame starting signal terminal is a low level. Alternatively, when the active level of the signal at the frame starting signal terminal is a low level, an active level of the signal output by the first shift register is a low level, so that the transistor connected to the first gate line is turned on. In this case, an inactive level of the signal at the frame starting signal terminal is a high level.

In some embodiments of the present disclosure, as shown in FIG. 3, the target shift register unit may further include second target shift register units (e.g., 122a, 122b); a driving output terminal of the first shift register in the second target shift register unit is coupled to at least one of the second gate lines (e.g., GA1_2, GA2_2, GA3_2). In some implementations, the driving output terminal of the first shift register in the second target shift register unit is coupled to one of the second gate lines.

In some implementations, for each second target shift register unit, when an active level of a signal at the frame starting signal terminal is a high level, an active level of a signal output by the first shift register is a high level, so that the transistor connected to the second gate line is turned on. In this case, an inactive level of the signal at the frame starting signal terminal is a low level. Alternatively, when the active level of the signal at the frame starting signal terminal is a low level, the active level of the signal output by the first shift register is a low level, so that the transistor connected to the second gate line is turned on. In this case, an inactive level of the signal at the frame starting signal terminal is a high level.

It should be noted that, in the embodiments of the present disclosure, the target shift register unit may include only the first target shift register units (e.g., 121a, 121b). Alternatively, the target shift register unit may include only the second target shift register units (e.g., 122a, 122b). Alternatively, the target shift register unit may include not only the first target shift register units (e.g., 121a, 121b), but also the second target shift register units (e.g., 122a, 122b). The embodiments of the present disclosure are described by taking a case where the target shift register unit includes not only the first target shift register units but also the second target shift register units as an example.

In some embodiments of the present disclosure, the display panel may adopt a single-side driving mode, or may adopt a dual-side driving mode. For example, in a case where the dual-side driving mode is adopted, the first shift registers in the target shift register unit includes a left first shift register and a right first shift register coupled to the gate line at two sides of the gate line; the left first shift register and the right first shift register are configured to simultaneously drive the gate line coupled thereto.

In some implementations, in the first target shift register units (e.g., 121a, 121b), the first shift registers include left first shift registers and right first shift registers coupled to the first gate lines at two sides of the first gate lines, respectively; the left first shift registers and the right first shift registers are configured to simultaneously drive the first gate lines (e.g., GA1_1, GA2_1, GA3_1) coupled thereto.

In some implementations, in the second target shift register units (e.g. 122a, 122b), the first shift registers include left first shift registers and right first shift registers coupled to the second gate lines at two sides of the second gate lines; the left first shift registers and the right first shift registers are configured to simultaneously drive the second gate lines (e.g., GA1_2, GA2_2, GA3_2) coupled thereto.

In some implementations, a plurality of first gate lines (e.g., GA1_1, GA2_1, GA3_1), a plurality of second gate lines (e.g., GA1_2, GA2_2, GA3_2), a plurality of light emission control signal lines (e.g., EM1, EM2, EM3), and a plurality of reset control lines (e.g., SA1, SA2, SA3) are shown in FIG. 3. The plurality of shift register units include: the first target shift register units 121a and 121b, the second target shift register units 122a and 122b, a light emission control circuit 123, and a reset control circuit 124.

In some implementations, as shown in FIG. 3, the first target shift register units 121a and 121b are both coupled to the first gate lines GA1_1, GA2_1, and GA3_1. Furthermore, the first target shift register unit 121a is located at the left side of the first gate lines coupled thereto, and the first target shift register unit 121b is located at the right side of the first gate lines coupled thereto.

In some implementations, as shown in FIG. 3, the second target shift register units 122a and 122b are both coupled to the second gate lines GA1_2, GA2_2, and GA3_2. Furthermore, the second target shift register unit 122a is located at the left side of the second gate lines coupled thereto, and the second target shift register unit 122b is located at the right side of the second gate lines coupled thereto.

In some implementations, as shown in FIG. 3, the light emission control circuit 123 is coupled to the light emission control signal lines EM1, EM2 and EM3. Furthermore, the light emission control circuit 123 is located on the left side of the light emission control signal lines EM1, EM2 and EM3 coupled thereto. Certainly, the light emission control circuit 123 may alternatively be located on the right side of the light emission control signal lines EM1, EM2 and EM3 coupled thereto, which is not limited herein.

In some implementations, as shown in FIG. 3, the reset control circuit 124 is coupled to the reset control lines SA1, SA2 and SA3. Furthermore, the reset control circuit 124 is located on the right of the reset control lines SA1, SA2 and SA3 coupled thereto. Certainly, the reset control circuit 124 may alternatively be located on the left side of the reset control lines SA1, SA2 and SA3 coupled thereto, which is not limited herein.

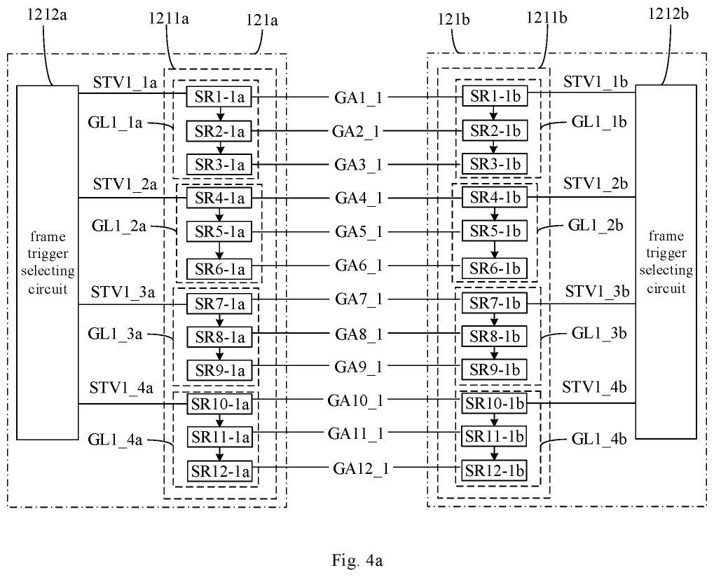

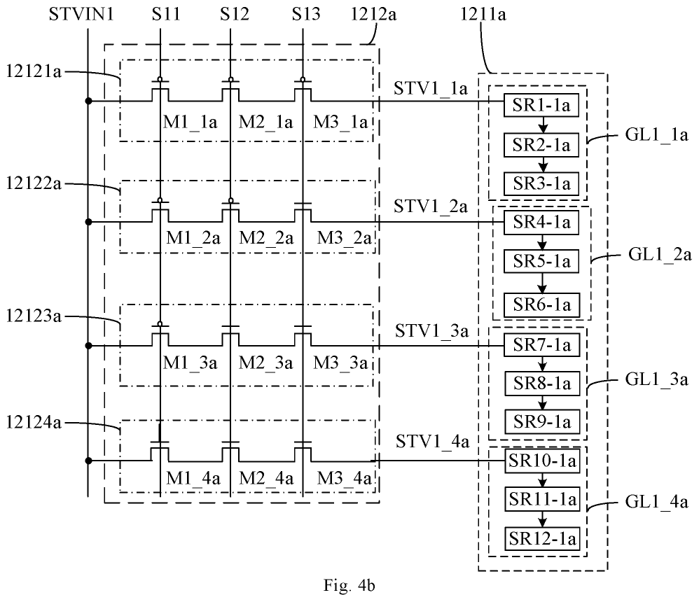

For example, taking N is equal to 4 as an example, as shown in FIG. 4a, the 121a may include: a gate driving circuit 1211a and a frame trigger selecting circuit 1212a. The gate driving circuit 1211a of the first target shift register unit 121a includes a plurality of first shift registers SR1-1a to SR12-1a, and the plurality of first shift registers are divided into four cascade groups including a first cascade group GL1_1a, a second cascade group GL1_2a, a third cascade group GL1_3a, and a fourth cascade group GL1_4a.

The first cascade group GL1_1a includes the first shift registers SR1-1a, SR2-1a and SR3-1a. An input signal terminal of the first shift register SR1-1a is coupled to the frame starting signal terminal STV1_1a, a driving output terminal of the first shift register SR1-1a is coupled to an input signal terminal of the first shift register SR2-1a, and a driving output terminal of the first shift register SR2-1a is coupled to an input signal terminal of the first shift register SR3-1a. Furthermore, the driving output terminal of the first shift register SR1-1a is coupled to the first gate line GA1_1, the driving output terminal of the first shift register SR2-1a is coupled to the first gate line GA2_1, and a driving output terminal of the first shift register SR3-1a is coupled to the first gate line GA3_1.

The second cascade group GL1_2a includes first shift registers SR4-1a, SR5-1a and SR6-1a. An input signal terminal of the first shift register SR4-1a is coupled to a frame starting signal terminal STV1_2a, a driving output terminal of the first shift register SR4-1a is coupled to an input signal terminal of the first shift register SR5-1a, and a driving output terminal of the first shift register SR5-1a is coupled to an input signal terminal of the first shift register SR6-1a. Furthermore, the driving output terminal of the first shift register SR4-1a is coupled to a first gate line GA4_1, the driving output terminal of the first shift register SR5_1a is coupled to a first gate line GA5_1, and a driving output terminal of the first shift register SR6-1a is coupled to a first gate line GA6_1.

The third cascade group GL1_3a includes first shift registers SR7-1a, SR8-1a and SR9-1a. An input signal terminal of the first shift register SR7-1a is coupled to a frame starting signal terminal STV1_3a, a driving output terminal of the first shift register SR7-1a is coupled to an input signal terminal of the first shift register SR8-1a, and a driving output terminal of the first shift register SR8-1a is coupled to an input signal terminal of the first shift register SR9-1a. Furthermore, the driving output terminal of the first shift register SR7-1a is coupled to a first gate line GA7_1, the driving output terminal of the first shift register SR8-1a is coupled to a first gate line GA8_1, and a driving output terminal of the first shift register SR9-1a is coupled to a first gate line GA9_1.

The fourth cascade group GL1_4a includes first shift registers SR10-1a, SR11-1a and SR12-1a. An input signal terminal of the first shift register SR10-1a is coupled to a frame starting signal terminal STV1_4a, a driving output terminal of the first shift register SR10-1a is coupled to an input signal terminal of the first shift register SR11-1a, and a driving output terminal of the first shift register SR11-1a is coupled to an input signal terminal of the first shift register SR12-1a. Furthermore, the driving output terminal of the first shift register SR10-1a is coupled to a first gate line GA10_1, the driving output terminal of the first shift register SR11-1a is coupled to a first gate line GA11_1, and a driving output terminal of the first shift register SR12-1a is coupled to a first gate line GA12_1.

In some implementations, as shown in FIG. 4a, the first target shift register unit 121b may include: a gate driving circuit 1211b and a frame trigger selecting circuit 1212b. The gate driving circuit 1211b of the first target shift register unit 121b includes a plurality of first shift registers SR1-1b to SR12-1b, and the plurality of first shift registers are divided into four cascade groups including a first cascade group GL1_1b, a second cascade group GL1_2b, a third cascade group GL1_3b, and a fourth cascade group GL1_4b.

The first cascade group GL1_1b includes first shift registers SR1-1b, SR2-1b and SR3-1b. An input signal terminal of the first shift register SR1-1b is coupled to a frame starting signal terminal STV1_1b, a driving output terminal of the first shift register SR1-1b is coupled to an input signal terminal of the first shift register SR2-1b, and a driving output terminal of the first shift register SR2-1b is coupled to an input signal terminal of the first shift register SR3-1b. Furthermore, the driving output terminal of the first shift register SR1-1b is coupled to the first gate line GA1_1, the driving output terminal of the first shift register SR2-1b is coupled to the first gate line GA2_1, and a driving output terminal of the first shift register SR3-1b is coupled to the first gate line GA3_1.

The second cascade group GL1_2b includes first shift registers SR4-1b, SR5-1b and SR6-1b. An input signal terminal of the first shift register SR4-1b is coupled to a frame starting signal terminal STV1_2b, a driving output terminal of the first shift register SR4-1b is coupled to an input signal terminal of the first shift register SR5-1b, and a driving output terminal of the first shift register SR5-1b is coupled to an input signal terminal of the first shift register SR6-1b. Furthermore, the driving output terminal of the first shift register SR4-1b is coupled to the first gate line GA4_1, the driving output terminal of the first shift register SR5-1b is coupled to the first gate line GA5_1, and a driving output terminal of the first shift register SR6-1b is coupled to the first gate line GA6_1.

The third cascade group GL1_3b includes first shift registers SR7-1b, SR8-1b and SR9-1b. An input signal terminal of the first shift register SR7-1b is coupled to a frame starting signal terminal STV1_3b, a driving output terminal of the first shift register SR7-1b is coupled to an input signal terminal of the first shift register SR8-1b, and a driving output terminal of the first shift register SR8-1b is coupled to an input signal terminal of the first shift register SR9-1b. Furthermore, the driving output terminal of the first shift register SR7-1b is coupled to the first gate line GA7_1, the driving output terminal of the first shift register SR8-1b is coupled to the first gate line GA8_1, and a driving output terminal of the first shift register SR9-1b is coupled to the first gate line GA9_1.

The fourth cascade group GL1_4b includes first shift registers SR10-1b, SR11-1b and SR12-1b. An input signal terminal of the first shift register SR10-1b is coupled to a frame starting signal terminal STV1_4b, a driving output terminal of the first shift register SR10-1b is coupled to an input signal terminal of the first shift register SR11-1b, and a driving output terminal of the first shift register SR11-1b is coupled to an input signal terminal of the first shift register SR12-1b. Furthermore, the driving output terminal of the first shift register SR10-1b is coupled to the first gate line GA10_1, the driving output terminal of the first shift register SR11-1b is coupled to the first gate line GA11_1, and a driving output terminal of the first shift register SR12-1b is coupled to the first gate line GA12_1.

In some implementations of the present disclosure, the frame trigger selecting circuit includes: N frame trigger selecting sub-circuits, the N frame trigger selecting sub-circuits corresponding to the N cascade groups and the N turn-on signals one by one; input terminals of the N frame trigger selecting sub-circuits are coupled to the frame trigger input terminal, and an output terminal of an n^{th} frame trigger selecting sub-circuit of the N frame trigger selecting sub-circuits is coupled to the frame starting signal terminal corresponding to the n^{th} cascade group; the n^{th} frame trigger selecting sub-circuit is configured to output, in response to an n^{th} turn-on signal, the starting signal input to the frame trigger input terminal to the frame starting signal terminal corresponding to the n^{th} cascade group.

In some implementations, as shown in FIG. 4b, the frame trigger selecting circuit 1212a of the first target shift register unit 121a may include: four frame trigger selecting sub-circuits (i.e., 12121a, 12122a, 12123a and 12124a). A first frame trigger selecting sub-circuit 12121a of the four frame trigger selecting sub-circuits corresponds to the first cascade group GL1_1a of the four cascade groups and a first on-signal of four turn-on-signals. A second frame trigger selecting sub-circuit 12122a of the four frame trigger selecting sub-circuits corresponds to the second cascade group GL1_2a of the four cascade groups and a second turn-on signal of the four turn-on signals. The third frame trigger selecting sub-circuit 12123a of the four frame trigger selecting sub-circuits corresponds to the third cascade group GL1_3a of the four cascade groups and a third turn-on signal of the four turn-on signals. The fourth frame trigger selecting sub-circuit 12124a of the four frame trigger selecting sub-circuits corresponds to the fourth cascade group GL1_4a of the four cascade groups and a fourth turn-on signal of the four turn-on signals. Furthermore, input terminals of the four frame trigger selecting sub-circuits (i.e., 12121a, 12122a, 12123a and 12124a) are coupled to a frame trigger input terminal STVIN1.

In some implementations, an output terminal of the first frame trigger selecting sub-circuit 12121a is coupled to the frame starting signal terminal STV1_1a corresponding to the first cascade group GL1_1a, and the first frame trigger selecting sub-circuit 12121a is configured to output, in response to the first turn-on signal, the starting signal input to the frame trigger input terminal STVIN1 to the frame starting signal terminal STV1_1a corresponding to the first cascade group GL1_1a.

In some implementations, an output terminal of the second frame trigger selecting sub-circuit 12122a is coupled to a frame starting signal terminal STV1_2a corresponding to the second cascade group GL1_2a, and the second frame trigger selecting sub-circuit 12122a is configured to output, in response to the second turn-on signal, the starting signal input to the frame trigger input terminal STVIN1 to the frame starting signal terminal STV1_2a corresponding to the second cascade group GL1_2a.

In some implementations, an output terminal of the third frame trigger selecting sub-circuit 12123a is coupled to a frame starting signal terminal STV1_3a corresponding to the third cascade group GL1_3a, and the third frame trigger selecting sub-circuit 12123a is configured to output, in response to the third turn-on signal, the starting signal input to the frame trigger input STVIN1 to the frame starting signal terminal STV1_3a corresponding to the third cascade group GL1_3a.

In some implementations, an output terminal of the fourth frame trigger selecting sub-circuit 12124a is coupled to a frame starting signal terminal STV1_4a corresponding to the fourth cascade group GL1_4a, and the fourth frame trigger selecting sub-circuit 12124a is configured to output, in response to the fourth turn-on signal, the starting signal input to the frame trigger input STVIN1 to the frame starting signal terminal STV1_4a corresponding to the fourth cascade group GL1_4a.

In some embodiments of the present disclosure, the display panel 100 further includes: M first turn-on signal lines coupled to the N frame trigger selecting sub-circuits, an n^{th} turn-on signal includes M level signals, and an m^{th} level signal of the M level signals is input through an m^{th} first turn-on signal line of the M first turn-on signal lines. In some implementations, M may be set to 1, 2, 3, 4, 5, 8 or more, which is not limited herein.

For example, taking M being equal to three as an example, as shown in FIG. 4b, the display panel may include three first turn-on signal lines (e.g., S11, S12 and S13); the four frame trigger selecting sub-circuits (i.e., 12121a, 12122a, 12123a and 12124a) in the first target shift register unit 121a each are coupled to the three first turn-on signal lines (e.g., S11, S12 and S13).

In some implementations, the first turn-on signal includes three level signals, a first level signal of the three level signals is input through a first first turn-on signal line S11 of the three first turn-on signal lines (e.g., S11, S12 and S13), a second level signal of the three level signals is input through a second first turn-on signal line S12 of the three first turn-on signal lines (e.g., S11, S12 and S13), and a third level signal of the three level signals is input through a third first turn-on signal line S13 of the three first turn-on signal lines (e.g., S11, S12 and S13). For example, a low level signal is represented by “0” and a high level signal is represented by “1”, and if the first turn-on signal is 000, the first first turn-on signal line S11 is input with a low level signal, the second first turn-on signal line S12 is input with a low level signal, and the third first turn-on signal line S13 is input with a low level signal.

The second turn-on signal includes three level signals, a first level signal of the three level signals is input through the first first turn-on signal line S11 of the three first turn-on signal lines (e.g., S11, S12 and S13), a second level signal of the three level signals is input through the second first turn-on signal line S12 of the three first turn-on signal lines (e.g., S11, S12 and S13), and the third level signal of the three level signals is input through the third first turn-on signal line S13 of the three first turn-on signal lines (e.g., S11, S12 and S13). For example, a low level signal is represented by “0” and a high level signal is represented by “1”, and if the second turn-on signal is 001, the first first turn-on signal line S11 is input with a low level signal, the second first turn-on signal line S12 is input with a low level signal, and the third first turn-on signal line S13 is input with a high level signal.

The third turn-on signal includes three level signals, a first level signal of the three level signals is input through the first first turn-on signal line S11 of the three first turn-on signal lines (e.g., S11, S12 and S13), a second level signal of the three level signals is input through the second first turn-on signal line S12 of the three first turn-on signal lines (e.g., S11, S12 and S13), and a third level signal of the three level signals is input through the third first turn-on signal line S13 of the three first turn-on signal lines (e.g., S11, S12 and S13). For example, a low level signal is represented by “0” and a high level signal is represented by “1”, and if the third turn-on signal is 011, the first first turn-on signal line S11 is input with a low level signal, the second first turn-on signal line S12 is input with a high level signal, and the third first turn-on signal line S13 is input with a high level signal.

The fourth turn-on signal includes three level signals, a first level signal of the three level signals is input through the first first turn-on signal line S11 of the three first turn-on signal lines (e.g., S11, S12 and S13), a second level signal of the three level signals is input through the second first turn-on signal line S12 of the three first turn-on signal lines (e.g., S11, S12 and S13), and a third level signal of the three level signals is input through the third first turn-on signal line S13 of the three first turn-on signal lines (e.g., S11, S12 and S13). For example, a low level signal is represented by “0” and a high level signal is represented by “1”, and if the fourth turn-on signal is 111, the first first turn-on signal line S11 is input with a high level signal, the second first turn-on signal line S12 is input with a high level signal, and the third first turn-on signal line S13 is input with a high level signal.

In some embodiments of the present disclosure, the n^{th} frame trigger selecting sub-circuit includes: M trigger transistors, an m^{th} trigger transistor of the M trigger transistors corresponds to the m^{th} first turn-on signal line, and a gate of the m^{th} trigger transistor is coupled to the m^{th} first turn-on signal line; a first electrode of the first trigger transistor of the M trigger transistors is coupled to the frame trigger input terminal, a second electrode of a former one of every two adjacent trigger transistors is coupled to a first electrode of a latter one of the two adjacent trigger transistors, and a second electrode of a last trigger transistor of the M trigger transistors is coupled to the frame starting signal terminal corresponding to the n^{th} cascade group.

In some embodiments of the present disclosure, the trigger transistors in at least part of the frame trigger selecting sub-circuits are different in type.

In some implementations, as shown in FIG. 4b, the first frame trigger selecting sub-circuit 12121a includes: three trigger transistors (e.g., M1_1a, M2_1a and M3_1a); a first trigger transistor M1_1a of the three trigger transistors corresponds to the first first turn-on signal line S11, a second trigger transistor M2_1a of the three trigger transistors corresponds to the second first turn-on signal line S12, and a third trigger transistor M3_1a of the three trigger transistors corresponds to the third first turn-on signal line S13. Moreover, a gate of the first trigger transistor M1_1a is coupled to the first first turn-on signal line S11, a gate of the second trigger transistor M2_1a is coupled to the second first turn-on signal line S12, and a gate of the third trigger transistor M3_1a is coupled to the third first turn-on signal line S13. Moreover, a first electrode of the first trigger transistor M1_1a is coupled to the frame starting signal terminal STVIN1, a second electrode of the first trigger transistor M1_1a is coupled to a first electrode of the second trigger transistor M2_1a, a second electrode of the second trigger transistor M2_1a is coupled to a first electrode of the third trigger transistor M3_1a, and a second electrode of the third trigger transistor M3_1a is coupled to the frame starting signal terminal STV1_1a corresponding to the first cascade group GL1_1a.

In some implementations, the first trigger transistor M1_1a of the three trigger transistors is a P-type transistor, the second trigger transistor M2_1a of the three trigger transistors is a P-type transistor, and the third trigger transistor M3_1a of the three trigger transistors is a P-type transistor. Thus, when the first turn-on signal is 000, all the trigger transistors M1_1a through M3_1a can be controlled to be turned on, so as to provide the signal of the frame trigger input terminal STVIN1 to the frame starting signal terminal STV1_1a.

The second frame trigger selecting sub-circuit 12122a includes: three trigger transistors (e.g., M1_2a, M2_2a and M3_2a); a first trigger transistor M1_2a of the three trigger transistors corresponds to the first first turn-on signal line S11, a second trigger transistor M2_2a of the three trigger transistors corresponds to the second first turn-on signal line S12, and a third trigger transistor M3_2a of the three trigger transistors corresponds to the third first turn-on signal line S13. Moreover, a gate of the first trigger transistor M1_2a is coupled to the first first turn-on signal line S11, a gate of the second trigger transistor M2_2a is coupled to the second first turn-on signal line S12, and a gate of the third trigger transistor M3_2a is coupled to the third first turn-on signal line S13. Furthermore, a first electrode of the first trigger transistor M1_2a is coupled to the frame starting signal terminal STVIN1, a second electrode of the first trigger transistor M1_2a is coupled to a first electrode of the second trigger transistor M2_2a, a second electrode of the second trigger transistor M2_2a is coupled to a first electrode of the third trigger transistor M3_2a, and a second electrode of the third trigger transistor M3_2a is coupled to the frame starting signal terminal STV1_2a corresponding to the second cascade group GL1_2a.

In some implementations, the first trigger transistor M1_2a of the three trigger transistors is a P-type transistor, the second trigger transistor M2_2a of the three trigger transistors is a P-type transistor, and the third trigger transistor M3_2a of the three trigger transistors is an N-type transistor. Thus, when the second turn-on signal is 001, all the trigger transistors M1_2a through M3_2a can be controlled to be turned on, so that the signal at the frame trigger input terminal STVIN1 is provided to the frame starting signal terminal STV1_2a.

The third frame trigger selecting sub-circuit 12123a includes: three trigger transistors (e.g., M1_3a, M2_3a and M3_3 a); the first trigger transistor M1_3a of the three trigger transistors corresponds to the first first turn-on signal line S11, a second trigger transistor M2_3a of the three trigger transistors corresponds to the second first turn-on signal line S12, and a third trigger transistor M3_3a of the three trigger transistors corresponds to the third first turn-on signal line S13. Moreover, a gate of the first trigger transistor M1_3a is coupled to the first first turn-on signal line S11, a gate of the second trigger transistor M2_3a is coupled to the second first turn-on signal line S12, and a gate of the third trigger transistor M3_3a is coupled to the third first turn-on signal line S13. Furthermore, a first electrode of the first trigger transistor M1_3a is coupled to the frame starting signal terminal STVIN1, a second electrode of the first trigger transistor M1_3a is coupled to a first electrode of the second trigger transistor M2_3a, a second electrode of the second trigger transistor M2_3a is coupled to a first electrode of the third trigger transistor M3_3a, and a second electrode of the third trigger transistor M3_3a is coupled to the frame starting signal terminal STV1_3a corresponding to the third cascade group GL1_3a.

In some implementations, the first trigger transistor M1_3a of the three trigger transistors is a P-type transistor, the second trigger transistor M2_3a of the three trigger transistors is an N-type transistor, and the third trigger transistor M3_3a of the three trigger transistors is an N-type transistor. Thus, when the third turn-on signal is 011, the trigger transistors M1_3a through M3_3a are all controlled to be turned on, so that the signal at the frame trigger input terminal STVIN1 is provided to the frame starting signal terminal STV1_3a.

The fourth frame trigger selecting sub-circuit 12124a includes: three trigger transistors (e.g., M1_4a, M2_4a and M3_4a); a first trigger transistor M1_4a of the three trigger transistors corresponds to the first first turn-on signal line S11, a second trigger transistor M2_4a of the three trigger transistors corresponds to the second first turn-on signal line S12, and a third trigger transistor M3_4a of the three trigger transistors corresponds to the third first turn-on signal line S13. Moreover, a gate of the first trigger transistor M1_4a is coupled to the first first turn-on signal line S11, a gate of the second trigger transistor M2_4a is coupled to the second first turn-on signal line S12, and a gate of the third trigger transistor M3_4a is coupled to the third first turn-on signal line S13. Furthermore, a first electrode of the first trigger transistor M1_4a of the three trigger transistors is coupled to the frame trigger input terminal STVIN1, a second electrode of the first trigger transistor M1_4a is coupled to a first electrode of a second trigger transistor M2_4a, a second electrode of the second trigger transistor M2_4a is coupled to a first electrode of a third trigger transistor M3_4a, and a second electrode of the third trigger transistor M3_4a is coupled to the frame starting signal terminal STV1_4a corresponding to the fourth cascade group GL1_4a.

In some implementations, the first trigger transistor M1_4a of the three trigger transistors is an N-type transistor, the second trigger transistor M2_4a of the three trigger transistors is an N-type transistor, and the third trigger transistor M3_4a of the three trigger transistors is an N-type transistor. Thus, when the first turn-on signal is 111, all the trigger transistors M1_4a through M3_4a can be controlled to be turned on, so as to provide the signal at the frame trigger input terminal STVIN1 to the frame starting signal terminal STV1_4a.

Certainly, the types of the trigger transistors M1_1a through M3_4a are only for illustration. In practical applications, the types of the trigger transistors M1_1a through M3_4a can be selected according to the level signals inputted from the first turn-on signal lines with which the gates of the trigger transistors are connected. For example, in a case where the trigger transistor is controlled to be turned on by a low level signal, a P-type trigger transistor may be selected as the trigger transistor. In a case where the trigger transistor is controlled to be turned on by a high level signal, an N-type trigger transistor may be selected as the trigger transistor.

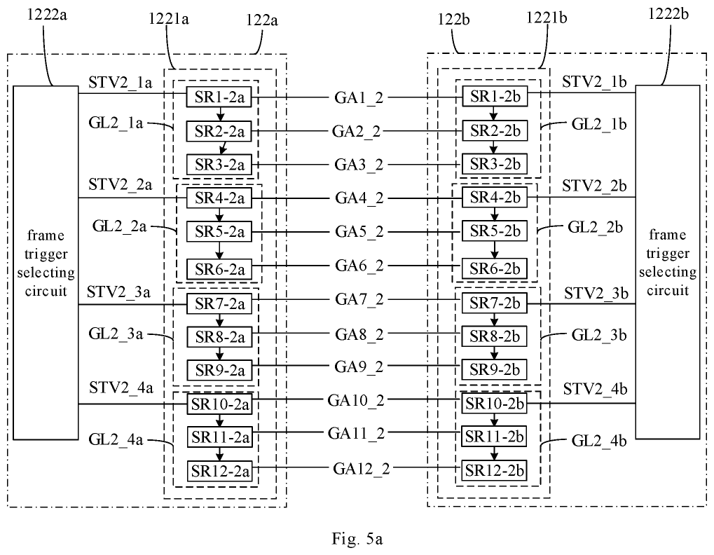

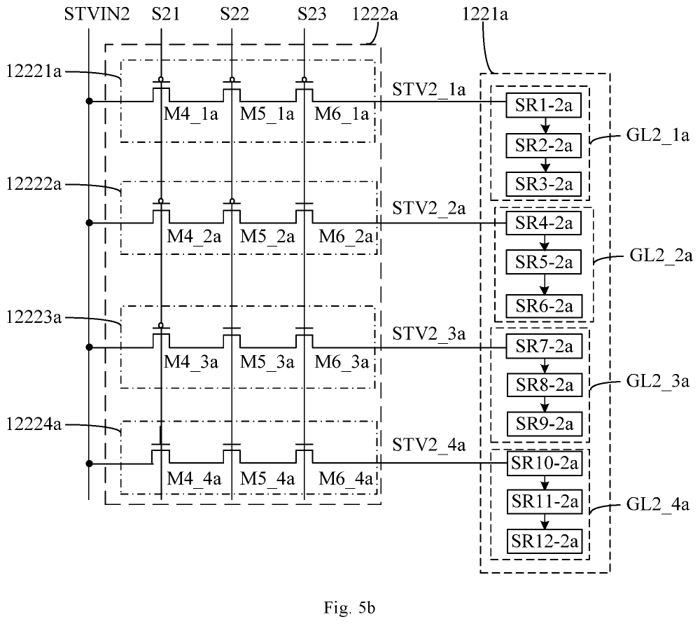

In some implementations, as shown in FIG. 5a, the second target shift register unit 122a may include: a gate driving circuit 1221a, and a frame trigger selecting circuit 1222a. The gate driving circuit 1221a in the second shift register unit 122a includes a plurality of first shift registers SR1-2a to SR12-2a, and the plurality of first shift registers are divided into four cascade groups including a first cascade group GL2_1a, a second cascade group GL2_2a, a third cascade group GL2_3a, and ta fourth cascade group GL2_4a.

The first cascade group GL2_1a includes first shift registers SR1-2a, SR2-2a and SR3-2a. An input signal terminal of the first shift register SR1-2a is coupled to a frame starting signal terminal STV2_1a, a driving output terminal of the first shift register SR1-2a is coupled to an input signal terminal of the first shift register SR2-2a, and a driving output terminal of the first shift register SR2-2a is coupled to an input signal terminal of the first shift register SR3-2a. Furthermore, the driving output terminal of the first shift register SR1-2a is coupled to a second gate line GA1_2, the driving output terminal of the first shift register SR2-2a is coupled to a second gate line GA2_2, and a driving output terminal of the first shift register SR3-2a is coupled to a second gate line GA3_2.

The second cascade group GL2_2a includes first shift registers SR4-2a, SR5-2a and SR6-2a. An input signal terminal of the first shift register SR4-2a is coupled to a frame starting signal terminal STV2_2a, a driving output terminal of the first shift register SR4-2a is coupled to an input signal terminal of the first shift register SR5-2a, and a driving output terminal of the first shift register SR5-2a is coupled to an input signal terminal of the first shift register SR6-2a. Furthermore, the driving output terminal of the first shift register SR4-2a is coupled to a second gate line GA4_2, the driving output terminal of the first shift register SR5-2a is coupled to a second gate line GA5_2, and a driving output terminal of the first shift register SR6-2a is coupled to a second gate line GA6_2.

The third cascade group GL2_3a includes first shift registers SR7-2a, SR8-2a and SR9-2a. An input signal terminal of the first shift register SR7-2a is coupled to a frame starting signal terminal STV2_3a, a driving output terminal of the first shift register SR7-2a is coupled to an input signal terminal of the first shift register SR8-2a, and a driving output terminal of the first shift register SR8-2a is coupled to an input signal terminal of the first shift register SR9-2a. Furthermore, the driving output terminal of the first shift register SR7-2a is coupled to a second gate line GA7_2, the driving output terminal of the first shift register SR8-2a is coupled to a second gate line GA8_2, and a driving output terminal of the first shift register SR9-2a is coupled to a second gate line GA9_2.

The fourth cascade group GL2_4a includes first shift registers SR10-2a, SR11-2a and SR12-2a. An input signal terminal of the first shift register SR10-2a is coupled to a frame starting signal terminal STV2_4a, a driving output terminal of the first shift register SR10-2a is coupled to an input signal terminal of the first shift register SR11-2a, and a driving output terminal of the first shift register SR11-2a is coupled to an input signal terminal of the first shift register SR12-2a. Furthermore, the driving output terminal of the first shift register SR10-2a is coupled to a second gate line GA10_2, the driving output terminal of the first shift register SR11-2a is coupled to a second gate line GA11_2, and a driving output terminal of the first shift register SR12-2a is coupled to a second gate line GA12_2.

In some implementations, as shown in FIG. 5a, the second target shift register unit 122b may include: a gate driving circuit 1221b, and a frame trigger selecting circuit 1222b. The gate driving circuit 1221b in the second shift register unit 122b includes a plurality of first shift registers SR1-2b to SR12-2b, and the plurality of first shift registers are divided into four cascade groups including a first cascade group GL2_1b, a second cascade group GL2_2b, a third cascade group GL2_3b, and a fourth cascade group GL2_4b.

The first cascade group GL2_1b includes first shift registers SR1-2b, SR2-2b and SR3-2b. An input signal terminal of the first shift register SR1-2b is coupled to a frame starting signal terminal STV2_1b, a driving output terminal of the first shift register SR1-2b is coupled to an input signal terminal of the first shift register SR2-2b, and a driving output terminal of the first shift register SR2-2b is coupled to an input signal terminal of the first shift register SR3-2b. Furthermore, the driving output terminal of the first shift register SR1-2b is coupled to the second gate line GA1_2, the driving output terminal of the first shift register SR2-2b is coupled to the second gate line GA2_2, and a driving output terminal of the first shift register SR3-2b is coupled to the second gate line GA3_2.

The second cascade group GL2_2b includes first shift registers SR4-2b, SR5-2b and SR6-2b. An input signal terminal of the first shift register SR4-2b is coupled to a frame starting signal terminal STV2_2b, a driving output terminal of the first shift register SR4-2b is coupled to an input signal terminal of the first shift register SR5-2b, and a driving output terminal of the first shift register SR5-2b is coupled to an input signal terminal of the first shift register SR6-2b. Furthermore, the driving output terminal of the first shift register SR4-2b is coupled to the second gate line GA4_2, the driving output terminal of the first shift register SR5-2b is coupled to the second gate line GA5_2, and a driving output terminal of the first shift register SR6-2b is coupled to the second gate line GA6_2.

The third cascade group GL2_3b includes first shift registers SR7-2b, SR8-2b and SR9-2b. An input signal terminal of the first shift register SR7-2b is coupled to a frame starting signal terminal STV2_3b, a driving output terminal of the first shift register SR7-2b is coupled to an input signal terminal of the first shift register SR8-2b, and a driving output terminal of the first shift register SR8-2b is coupled to an input signal terminal of the first shift register SR9-2b. Furthermore, the driving output terminal of the first shift register SR7-2b is coupled to the second gate line GA7_2, the driving output terminal of the first shift register SR8-2b is coupled to the second gate line GA8_2, and a driving output terminal of the first shift register SR9-2b is coupled to the second gate line GA9_2.

The fourth cascade group GL2_4b includes first shift registers SR10-2b, SR11-2b and SR12-2b. An input signal terminal of the first shift register SR10-2b is coupled to a frame starting signal terminal STV2_4b, a driving output terminal of the first shift register SR10-2b is coupled to an input signal terminal of the first shift register SR11-2b, and a driving output terminal of the first shift register SR11-2b is coupled to an input signal terminal of the first shift register SR12-2b. Furthermore, the driving output terminal of the first shift register SR10-2b is coupled to the second gate line GA10_2, the driving output terminal of the first shift register SR11-2b is coupled to the second gate line GA11_2, and a driving output terminal of the first shift register SR12-2b is coupled to the second gate line GA12_2.

In some implementations, as shown in FIG. 5b, the frame trigger selecting circuit 1222a in the second target shift register unit 122a includes: four frame trigger selecting sub-circuits (i.e., 12221a, 12222a, 12223a and 12224a); a first frame trigger selecting sub-circuit 12221a of the four frame trigger selecting sub-circuits corresponds to the first cascade group GL2_1a of the four cascade groups and a first turn-on signal of four turn-on signals. A second frame trigger selecting sub-circuit 12222a of the four frame trigger selecting sub-circuits corresponds to the second cascade group GL2_2a of the four cascade groups and a second turn-on signal of the four turn-on signals. A third frame trigger selecting sub-circuit 12223a of the four frame trigger selecting sub-circuits corresponds to the third cascade group GL2_3a of the four cascade groups and a third turn-on signal of the four turn-on signals. A fourth frame trigger selecting sub-circuit 12224a of the four frame trigger selecting sub-circuits corresponds to the fourth cascade group GL2_4a of the four cascade groups and a fourth turn-on signal of the four turn-on signals. Input terminals of the four frame trigger selecting sub-circuits (i.e., 12221a, 12222a, 12223a and 12224a) are coupled to the frame trigger input STVIN2.

In some implementations, as shown in FIG. 5b, an output terminal of the first frame trigger selecting sub-circuit 12221a is coupled to the frame starting signal terminal STV2_1a corresponding to the first cascade group GL2_1a. Moreover, the first frame trigger selecting sub-circuit 12221a is configured to output, in response to the first turn-on signal, a starting signal input to the frame trigger input STVIN2 to the frame starting signal terminal STV2_1a corresponding to the first cascade group GL2_1a.

In some implementations, as shown in FIG. 5b, an output terminal of the second frame trigger selecting sub-circuit 12222a is coupled to the frame starting signal terminal STV2_2a corresponding to the second cascade group GL2_2a. Furthermore, the second frame trigger selecting sub-circuit 12222a is configured to output, in response to the second turn-on signal, the starting signal input to the frame trigger input STVIN2 to the frame starting signal terminal STV2_2a corresponding to the second cascade group GL2_2a.

In some implementations, as shown in FIG. 5b, an output terminal of the third frame trigger selecting sub-circuit 12223a is coupled to the frame starting signal terminal STV2_3a corresponding to the third cascade group GL2_3a. Furthermore, the third frame trigger selecting sub-circuit 12223a is configured to output, in response to the third turn-on signal, the starting signal input to the frame trigger input STVIN2 to the frame starting signal terminal STV2_3a corresponding to the third cascade group GL2_3a.

In some implementations, as shown in FIG. 5b, an output terminal of the fourth frame trigger selecting sub-circuit 12224a is coupled to the frame starting signal terminal STV2_4a corresponding to the fourth cascade group GL2_4a. Furthermore, the fourth frame trigger selecting sub-circuit 12224a is configured to output, in response to the fourth turn-on signal, the starting signal input to the frame trigger input STVIN2 to the frame starting signal terminal STV2_4a corresponding to the fourth cascade group GL2_4a.

In some implementations, taking M being equal to 3 as an example, as shown in FIG. 5b, the display panel may include three first turn-on signal lines (e.g., S21, S22 and S23); the four frame trigger selecting sub-circuits (i.e., 12221a, 12222a, 12223a and 12224a) in the second target shift register unit 122a each are coupled to the three first turn-on signal lines (e.g., S21, S22 and S23).

In some implementations, the first turn-on signal includes three level signals, a first level signal of the three level signals is input through a first first turn-on signal line S21 of the three first turn-on signal lines (e.g., S21, S22 and S23), a second level signal of the three level signals is input through a second first turn-on signal line S22 of the three first turn-on signal lines (e.g., S21, S22 and S23), and a third level signal of the three level signals is input through a third first turn-on signal line S23 of the three first turn-on signal lines (e.g., S21, S22 and S23). For example, a low level signal is represented by “0” and a high level signal is represented by “1”, and if the first turn-on signal is 000, the first first turn-on signal line S21 is input with a low level signal, the second first turn-on signal line S22 is input with a low level signal, and the third first turn-on signal line S23 is input with a low level signal.

In some implementations, the second turn-on signal includes three level signals, a first level signal of the three level signals is input through the first first turn-on signal line S21 of the three first turn-on signal lines (e.g., S21, S22 and S23), a second level signal of the three level signals is input through the second first turn-on signal line S22 of the three first turn-on signal lines (e.g., S21, S22 and S23), and a third level signal of the three level signals is input through the third first turn-on signal line S23 of the three first turn-on signal lines (e.g., S21, S22 and S23). For example, a low level signal is represented by “0” and a high level signal is represented by “1”, and if the second turn-on signal is 001, the first first turn-on signal line S21 is iniput with a low level signal, the second first turn-on signal line S22 is input with a low level signal, and the third first turn-on signal line S23 is input with a high level signal.

In some implementations, the third turn-on signal includes three level signals, a first level signal of the three level signals is input through the first first turn-on signal line S21 of the three first turn-on signal lines (e.g., S21, S22 and S23), a second level signal of the three level signals is input through the second first turn-on signal line S22 of the three first turn-on signal lines (e.g., S21, S22 and S23), and a third level signal of the three level signals is input through the third first turn-on signal line S23 of the three first turn-on signal lines (e.g., S21, S22 and S23). For example, a low level signal is represented by “0” and a high level signal is represented by “1”, and if the third turn-on signal is 011, the first first turn-on signal line S21 is input with a low-level signal, the second first turn-on signal line S22 is input with a high-level signal, and the third first turn-on signal line S23 is input with a high-level signal.

In some implementations, the fourth turn-on signal includes three level signals, a first level signal of the three level signals is input through the first first turn-on signal line S21 of the three first turn-on signal lines (e.g., S21, S22 and S23), a second level signal of the three level signals is input through the second first turn-on signal line S22 of the three first turn-on signal lines (e.g., S21, S22 and S23), and a third level signal of the three level signals is input through the third first turn-on signal line S23 of the three first turn-on signal lines (e.g., S21, S22 and S23). For example, a low level signal is represented by “0” and a high level signal is represented by “1”, and if the fourth turn-on signal is 111, the first first turn-on signal line S21 is input with a high level signal, the second first turn-on signal line S22 is input with a high level signal, and the third first turn-on signal line S23 is input with a high level signal.

In some implementations, as shown in FIG. 5b, the first frame trigger selecting sub-circuit 12221a includes: three trigger transistors (e.g., M4_1a, M5_1a and M6_1a); a first trigger transistor M4_1a of the three trigger transistors corresponds to the first first turn-on signal line S21, a second trigger transistor M5_1a of the three trigger transistors corresponds to the second first turn-on signal line S22, and a third trigger transistor M6_1a of the three trigger transistors corresponds to the third first turn-on signal line S23. Moreover, a gate of the first trigger transistor M4_1a is coupled to the first first turn-on signal line S21, a gate of the second trigger transistor M5_1a is coupled to the second first turn-on signal line S22, and a gate of the third trigger transistor M6_1a is coupled to the third first turn-on signal line S23. Furthermore, a first electrode of the first trigger transistor M4_1a of the three trigger transistors is coupled to the frame trigger input STVIN2, a second electrode of the first trigger transistor M4_1a is coupled to a first electrode of the second trigger transistor M5_1a, a second electrode of the second trigger transistor M5_1a is coupled to a first electrode of a third trigger transistor M6_1a, and a second electrode of the third trigger transistor M6_1a is coupled to the frame starting signal terminal STV2_1a corresponding to the first cascade group GL2_1a.

In some implementations, the first trigger transistor M4_1a of the three trigger transistors is a P-type transistor, the second trigger transistor M5_1a of the three trigger transistors is a P-type transistor, and the third trigger transistor M6_1a of the three trigger transistors is a P-type transistor. Thus, when the first turn-on signal is 000, all the trigger transistors M4_1a through M6_1a can be controlled to be turned on, so as to provide the signal at the frame trigger input terminal STVIN2 to the frame starting signal terminal STV2_1a.

In some implementations, as shown in FIG. 5b, the second frame trigger selecting sub-circuit 12222a includes: three trigger transistors (e.g., M4_2a, M5_2a and M6_2a); a first trigger transistor M4_2a of the three trigger transistors corresponds to the first first turn-on signal line S21, a second trigger transistor M5_2a of the three trigger transistors corresponds to the second first turn-on signal line S22, and a third trigger transistor M6_2a of the three trigger transistors corresponds to the third first turn-on signal line S23. Moreover, a gate of the first trigger transistor M4_2a is coupled to the first first turn-on signal line S21, a gate of the second trigger transistor M5_2a is coupled to the second first turn-on signal line S22, and a gate of the third trigger transistor M6_2a is coupled to the third first turn-on signal line S23. Furthermore, a first electrode of the first trigger transistor M4_2a of the three trigger transistors is coupled to the frame trigger input STVIN2, a second electrode of the first trigger transistor M4_2a is coupled to a first electrode of the second trigger transistor M5_2a, a second electrode of the second trigger transistor M5_2a is coupled to a first electrode of a third trigger transistor M6_2a, and a second electrode of the third trigger transistor M6_2a is coupled to the frame starting signal terminal STV2_2a corresponding to the second cascade group GL2_2a.

In some implementations, the first trigger transistor M4_2a of the three trigger transistors is a P-type transistor, the second trigger transistor M5_2a of the three trigger transistors is a P-type transistor, and the third trigger transistor M6_2a of the three trigger transistors is an N-type transistor. Thus, when the second turn-on signal is 001, all the trigger transistors M4_2a through M6_2a can be controlled to be turned on, so that the signal at the frame trigger input terminal STVIN2 is provided to the frame starting signal terminal STV2_2a.

In some implementations, as shown in FIG. 5b, the third frame trigger selecting sub-circuit 12223a includes three trigger transistors (e.g., M4_3a, M5_3a and M6_3a); a first trigger transistor M4_3a of the three trigger transistors corresponds to the first first turn-on signal line S21, a second trigger transistor M5_3a of the three trigger transistors corresponds to the second first turn-on signal line S22, and a third trigger transistor M6_3a of the three trigger transistors corresponds to the third first turn-on signal line S23. Moreover, a gate of the first trigger transistor M4_3a is coupled to the first first turn-on signal line S21, a gate of the second trigger transistor M5_3a is coupled to the second first turn-on signal line S22, and a gate of the third trigger transistor M6_3a is coupled to the third first turn-on signal line S23. Furthermore, a first electrode of the first trigger transistor M4_3a of the three trigger transistors is coupled to the frame trigger input STVIN2, a second electrode of the first trigger transistor M4_3a is coupled to a first electrode of the second trigger transistor M5_3a, a second electrode of the second trigger transistor M5_3a is coupled to a first electrode of a third trigger transistor M6_3a, and a second electrode of the third trigger transistor M6_3a is coupled to the frame starting signal terminal STV2_3a corresponding to the third cascade group GL2_3a.

In some implementations, the first trigger transistor M4_3a of the three trigger transistors is a P-type transistor, the second trigger transistor M5_3a of the three trigger transistors is an N-type transistor, and the third trigger transistor M6_3a of the three trigger transistors is an N-type transistor. Thus, when the third turn-on signal is 011, the trigger transistors M4_3a through M6_3a are all controlled to be turned on, so that the signal at the frame trigger input terminal STVIN2 is provided to the frame starting signal terminal STV2_3a.

In some implementations, as shown in FIG. 5b, the fourth frame trigger selecting sub-circuit 12224a includes three trigger transistors (e.g., M4_4a, M5_4a and M6_4a); a first trigger transistor M4_4a of the three trigger transistors corresponds to the first first turn-on signal line S21, a second trigger transistor M5_4a of the three trigger transistors corresponds to the second first turn-on signal line S22, and a third trigger transistor M6_4a of the three trigger transistors corresponds to the third first turn-on signal line S23. Moreover, a gate of the first trigger transistor M4_4a is coupled to the first first turn-on signal line S21, a gate of the second trigger transistor M5_4a is coupled to the second first turn-on signal line S22, and a gate of the third trigger transistor M6_4a is coupled to the third first turn-on signal line S23. Furthermore, a first electrode of the first trigger transistor M4_4a of the three trigger transistors is coupled to the frame trigger input STVIN2, a second electrode of the first trigger transistor M4_4a is coupled to a first electrode of the second trigger transistor M5_4a, a second electrode of the second trigger transistor M5_4a is coupled to a first electrode of a third trigger transistor M6_4a, and a second electrode of the third trigger transistor M6_4a is coupled to the frame starting signal terminal STV2_4a corresponding to the fourth cascade group GL2_4a.

In some implementations, the first trigger transistor M4_4a of the three trigger transistors is an N-type transistor, the second trigger transistor M5_4a of the three trigger transistors is an N-type transistor, and the third trigger transistor M6_4a of the three trigger transistors is an N-type transistor. Thus, when the fourth turn-on signal is 111, all the trigger transistors M4_4a through M6_4a can be controlled to be turned on, so that the signal at the frame trigger input terminal STVIN2 is provided to the frame starting signal terminal STV2_4a.

Certainly, the types of the trigger transistors M4_1a through M6_4a are only for illustration. In practical applications, the types of the trigger transistors M4_1a through M6_4a can be selected according to the level signals inputted from the first turn-on signal lines with which the gates of the trigger transistors are connected. For example, in a case where the trigger transistor is controlled to be turned on by a low level signal, a P-type transistor may be selected as the trigger transistor. In a case where the trigger transistor is turned on by a high level signal, an N-type transistor may be selected as the trigger transistor.

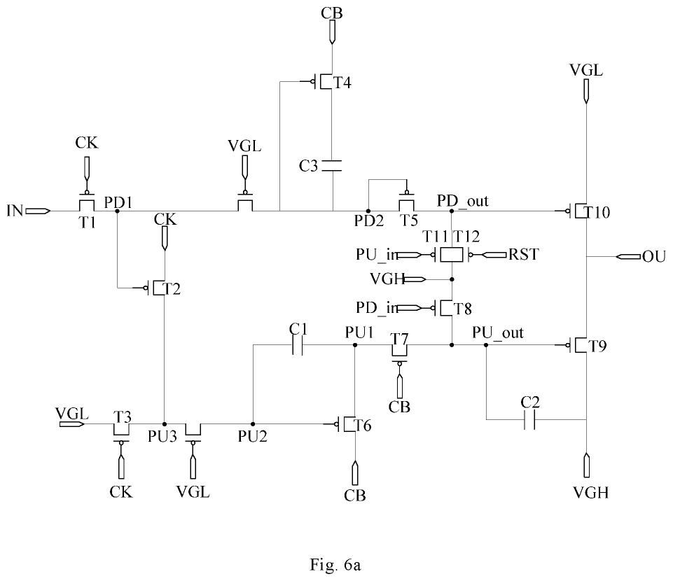

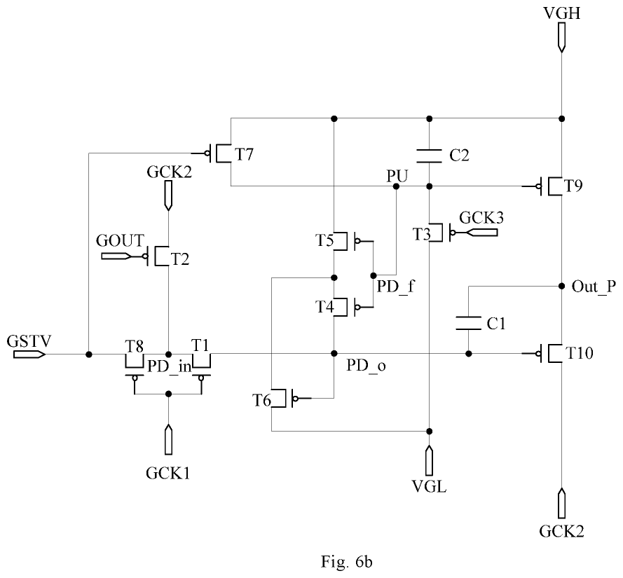

In some embodiments of the present disclosure, each first shift register may include a plurality of transistors and a plurality of capacitors. In some implementations, as shown in FIG. 6a, each first shift register may include: transistors T1 to T12, and capacitors C1 to C3. The first shift register is coupled to an input signal terminal IN, a clock signal terminal CK, a control signal terminal CB, a reset signal terminal RST, a PU input signal terminal PU_IN, a PD input signal terminal PD_IN, a first reference voltage terminal VGL, a second reference voltage terminal VGH, a first node PU1, a second node PU2, a third node PU3, a fourth node PD1, a fifth node PD2, a sixth node PU_out, and a seventh node PD_out.

In some implementations, alternatively, as shown in FIG. 6b, each first shift register may include: transistors T1 to T10, and capacitors C1 to C2. The first shift register is coupled to a signal input terminal GSTV, a signal output terminal GOUT, a first clock signal terminal GCK1, a second clock signal terminal GCK2, a third clock signal terminal GCK3, a first reference voltage terminal VGL, a second reference voltage terminal VGH, a first node PD_in, a second node PD_o, a third node PD_f, a fourth node PU and a fifth node Out P.

In some implementations, the light emission control circuit includes a plurality of second shift registers, a driving output terminal of each second shift register being coupled to at least one of the light emission control signal lines (EM). For example, the driving output terminal of each second shift register is coupled to one of the light emission control signal lines (EM).

In some implementations, the reset control circuit includes a plurality of third shift registers, and a driving output terminal of each third shift register is coupled to at least one of the reset control signal lines (SA). For example, the driving output terminal of each third shift register is coupled to one of the reset control signal lines (SA).

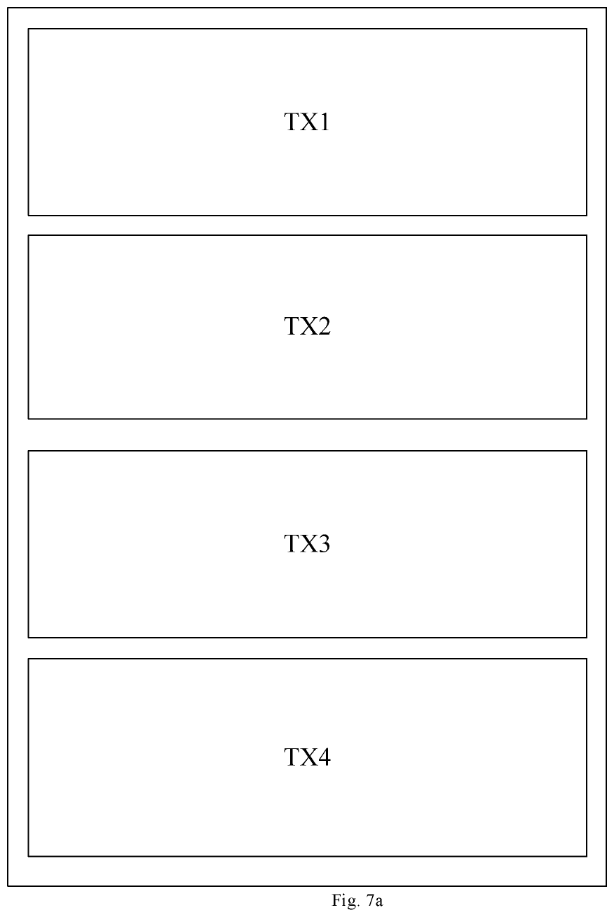

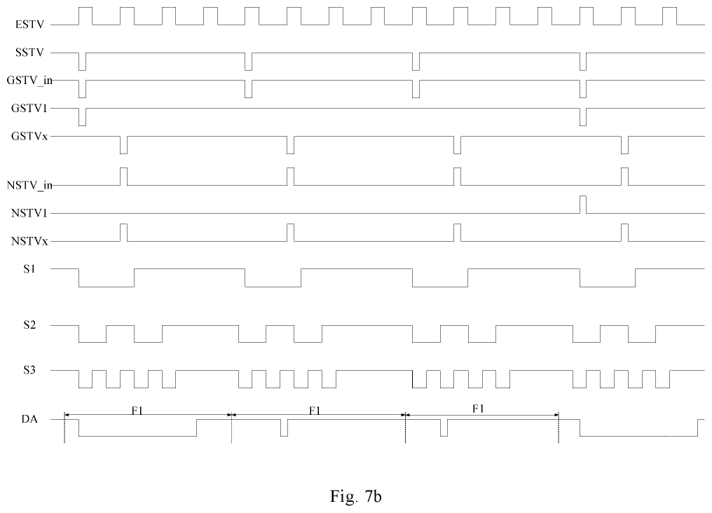

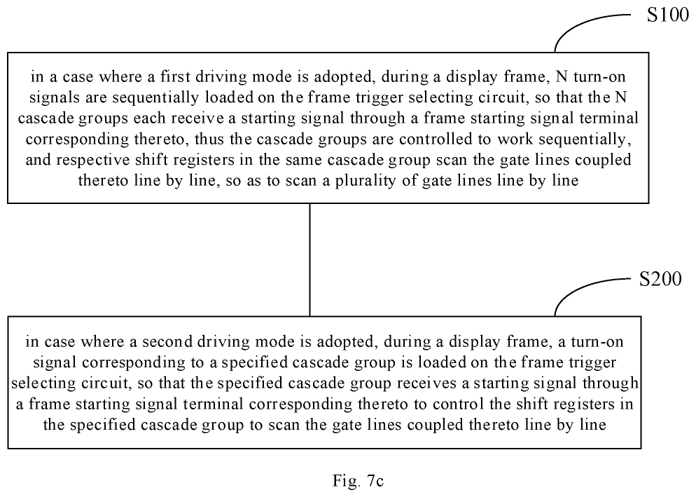

In some implementations, continuing to take a case where N is equal to 4 as an example, since four cascade groups are divided, as shown in FIG. 7a, the display panel may be divided into four regions including a first image region TX1, a second image region TX2, a third image region TX3, and a fourth image region TX4. In the present embodiment, at least one of the four image regions may be selectively driven by selecting at least one of the first cascade group to the fourth cascade group. For example, by selecting any one of the first cascade group to the fourth cascade group, any one of the four image regions may be selectively driven.

The above is merely an example of the specific structure of the display panel provided in the embodiment of the present disclosure, and in the implementation of the specific structure, the specific structure is not limited to the structure provided in the embodiment of the present disclosure, and may be other structures known to those skilled in the art, and is not limited herein.

In some implementations, as shown in FIG. 7b, ESPV represents a signal on the light emission control signal line, SSTV represents a signal on the reset control signal line, GSTV_in represents a signal at the frame trigger input terminal, GSTV1 represents a signal refreshed by the first target shift register unit in a low frequency, GSTVx represents a signal refreshed by the first target shift register unit in a high frequency, NSTV_in represents a signal at the frame trigger input terminal, NSTVI represents a signal refreshed by the second target shift register unit in a low frequency, NSTVx represents a signal refreshed by the second target shift register unit in a high frequency, S1 represents a signal on the first first turn-on signal line, S2 represents a signal on the second first turn-on signal line, S3 represents a signal on the third first turn-on signal line, DA represents a signal on the data line, and F1 represents a refresh frame.

As shown in FIG. 7c, a method for driving a display panel according to an embodiment of the present disclosure includes the following steps S100 and S200.

At step S100, in a case where a first driving mode is adopted, during a display frame, N turn-on signals are sequentially loaded on the frame trigger selecting circuit, so that the N cascade groups each receive a starting signal through a frame starting signal terminal corresponding thereto, thus the cascade groups are controlled to operate in sequence, and respective shift registers in the same cascade group scan the gate lines coupled thereto line by line, so as to scan a plurality of gate lines line by line.

At step S200, in case where a second driving mode is adopted, during a display frame, a turn-on signal corresponding to a specified cascade group is loaded on the frame trigger selecting circuit, so that the specified cascade group receives a starting signal through a frame starting signal terminal corresponding thereto to control the shift registers in the specified cascade group to scan the gate lines coupled thereto line by line.

In the embodiment of the present disclosure, the method further includes: in the case where the second driving mode is adopted, a frame trigger selecting circuit is loaded with a turn-off signal corresponding to the remaining cascade groups of the plurality of cascade groups other than the specified cascade group.

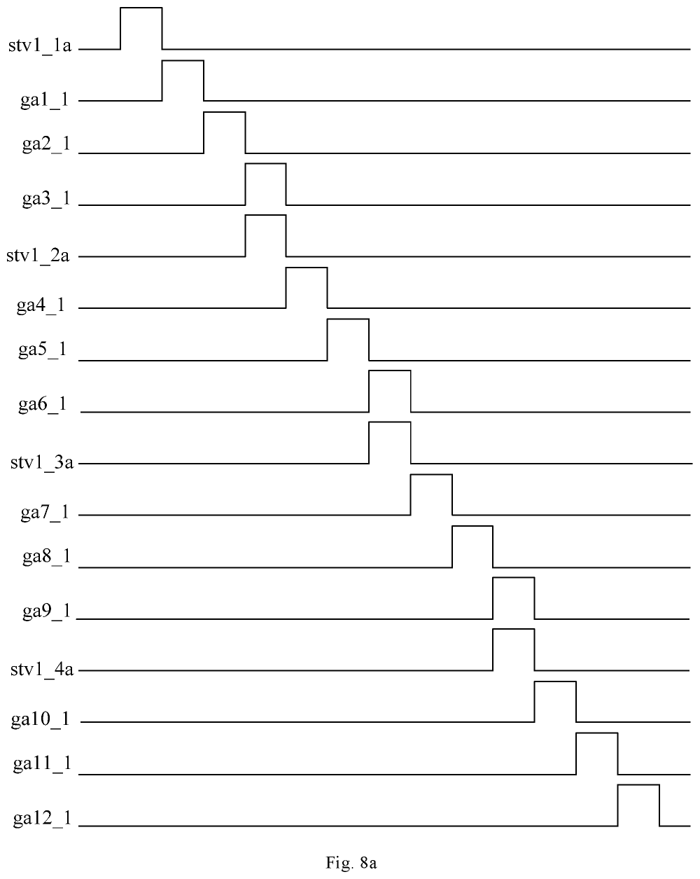

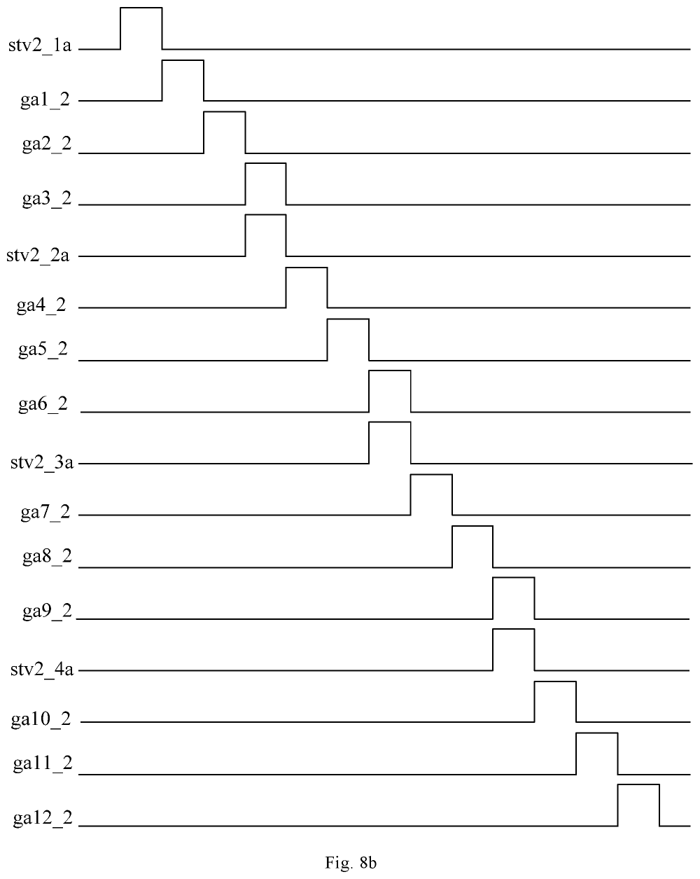

In some implementations, with reference to FIG. 4b to FIG. 5b, in a case where the display panel provided by the embodiment of the present disclosure adopts the first driving mode, corresponding signal timing diagrams are shown in FIG. 7b, FIG. 8a and FIG. 8b. In the tingming diagrams, stv1_1a represents a signal at the frame starting signal terminal STV1_1a, stv1_2a represents a signal at the frame starting signal terminal STV1_2a, stv1_3a represents a signal at the frame starting signal terminal STV1_3a, stv1_4a represents a signal at the frame starting signal terminal STV1_4a, ga1_1 represents a signal input to the first gate line GA1_1a from the driving output terminal of the first shift register SR1-1a, ga2_1 represents a signal input to the first gate line GA2_1 from the driving output terminal of the first shift register SR2-1a, ga3_1 represents a signal input to the first gate line GA3_1 from the driving output terminal of the first shift register SR3-1a, ga4_1 represents a signal input to the gate line GA4_1 from the driving output terminal of the first shift register SR4-1a, ga5_1 represents a signal input to the first gate line GA5_1 from the driving output terminal of the first shift register SR5-1a, ga6_1 represents a signal input to the first gate line GA6_1 from the driving output terminal of the first shift register SR6-1a, ga7_1 represents a signal input to the first gate line GA7_1 from the driving output terminal of the first shift register SR7-1a, ga8_1 represents a signal input to the first gate line GA8_1 from the driving output terminal of the first shift register SR8-1a, ga9_1 represents a signal input to the first gate line GA9_1 from the driving output terminal of the first shift register SR9-1a, ga10_1 represents a signal input to the first gate line GA10_1 from the driving output terminal of the first shift register SR10-1a, ga11_1 represents a signal input to the first gate line GA11_1 from the driving output terminal of the first shift register SR11-1a, and ga12_1 represents a signal input to the first gate line GA12_1 from the driving output terminal of the first shift register SR12-1a.

In a case wher the first driving mode is adopted, during a display frame, by control of the first turn-on signal and the fourth turn-on signal, the signal stv1_1a is applied to the frame starting signal terminal STV1_1a, the signal stv1_2a is applied to the frame starting signal terminal STV1_2a, the signal stv1_3a is applied to the frame starting signal terminal STV1_3a, and the signal stv1_4a is applied to the frame starting signal terminal STV1_4a. The signal stv1_1a is applied to the frame starting signal terminal STV1_1a, so that the first shift registers in the first cascade group GL1_1a are controlled to output the signals ga1_1, ga2_1 and ga3_1 to the first gate lines GA1_1, GA2_1 and GA3_1 coupled thereto; the signal stv1_2a is applied to the frame starting signal terminal STV1_2a, so that the first shift registers in the second cascade group GL1_2a are controlled to output the signals ga4_1, ga5_1 and ga6_1 to the first gate lines GA4_1, GA5_1 and GA6_1 coupled thereto; the signal stv1_3a is applied to the frame starting signal terminal STV1_3a, so that the first shift registers in the third cascade group GL1_3a are controlled to output the signals ga7_1, ga8_1 and ga9_1 to the first gate lines GA7_1, GA8_1 and GA9_1 coupled thereto; the signal atv1_4a is applied to the frame starting signal terminal STV1_4a, so that the first shift registers in the fourth cascade group GL1_4a is controlled to output the signals ga10_1, gal1_1 and ga12_1 to the first gate lines GA10_1, GA11_1 and GA12_1 coupled thereto, therefor, a refresh is implemented by scanning line by line (progressive scan).

Furthermore, stv2_1a represents a signal at the frame starting signal terminal STV2_1a, stv2_2a represents a signal at the frame starting signal terminal STV2_2a, stv2_3a represents a signal at the frame starting signal terminal STV2_3a, stv2_4a represents a signal at the frame starting signal terminal STV2_4a, ga1_2 represents a signal input to the second gate line GA1_2 from the driving output terminal of the first shift register SR1-1a, ga2_2 represents a signal input to the second gate line GA2_2 from the driving output terminal of the first shift register SR2-1a, ga3_2 represents a signal input to the second gate line GA3_2 from the driving output terminal of the first shift register SR3-1a, ga4_2 represents a signal input to the second gate line GA4_2 from the driving output terminal of the first shift register SR4-1a, and ga5_2 represents a signal input to the second gate line GA5_2 from the driving output terminal of the first shift register SR5-1a, the ga6_2 represents a signal input to the second gate line GA6_2 from the driving output terminal of the first shift register SR6-1a, ga7_2 represents a signal input to the second gate line GA7_2 from the driving output terminal of the first shift register SR7-1a, ga8_2 represents a signal input to the second gate line GA8_2 from the driving output terminal of the first shift register SR8-1a, ga9_2 represents a signal input to the second gate line GA9_2 from the driving output terminal of the first shift register SR9-1a, ga10_2 represents a signal input to the second gate line GA10_2 from the driving output terminal of the first shift register SR10-1a, gal1_2 represents a signal input to the second gate line GA11_2 from the driving output terminal of the first shift register SR11-1a, and ga12_2 represents a signal input to the second gate line GA12_2 from the driving output terminal of the first shift register SR12-1a.

In a case where the first driving mode is adopted, during a display frame, by control of the first turn-on signal and the fourth turn-on signal, the signal stv2_1a is applied to the frame starting signal terminal STV2_1a, the signal stv2_2a is applied to a frame starting signal terminal STV2_2a, the signal stv2_3a is applied to the frame starting signal terminal STV2_3a, and the signal stv2_4a is applied to the frame starting signal terminal STV2_4a. The signal stv2_1a is applied to the frame starting signal terminal STV2_1a, so that the first shift registers in the first cascade group GL2_1a are controlled to output the signals ga1_2, ga2_2 and ga3_2 to the second gate lines GA1_2, GA2_2 and GA3_2 coupled thereto; the signal stv2_2a is applied to the frame starting signal terminal STV2_2a, so that the first shift registers in the asecond cascade group GL2_2a are controlled to output the signals ga4_2, ga5_2 and ga6_2a to the second gate lines GA4_2, GA5_2 and GA6_2 coupled thereto; the signal stv2_3a is applied to the frame starting signal terminal STV2_3a, so that the first shift registers in the third cascade group GL2_3a are controlled to output the signals ga7_2, ga8_2 and ga9_2a to the second gate line GA7_2, GA8_2 and GA9_2 coupled thereto; the signal STV2_4a is applied to the frame starting signal terminal STV2_4a, so that the first shift registers in the fourth cascade group GL2_4a are controlled to output the signals ga10_2, gal1_2 and ga12_2 to the second gate lines GA10_2, GA11_2 and GA12_2 coupled thereto, therefore, a refresh is implemented by scanning line by line.

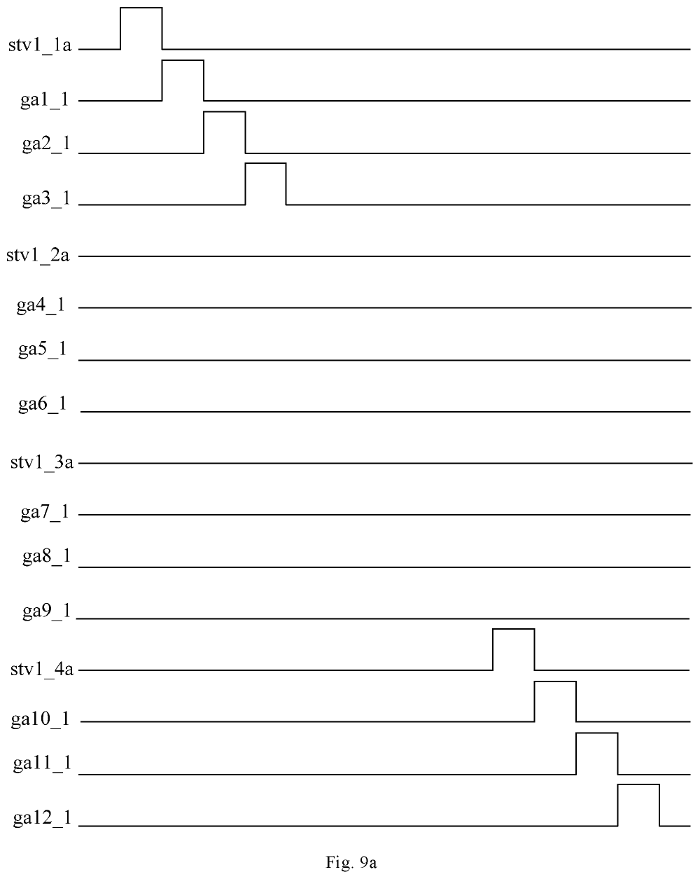

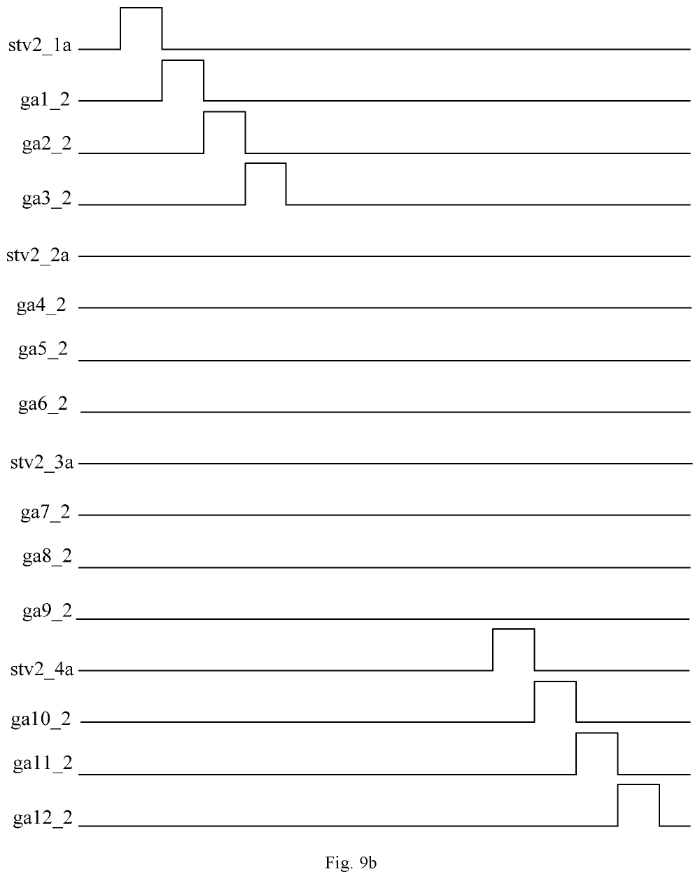

In some implementations, with reference to FIG. 4b to FIG. 5b, in a case where the display panel provided by the embodiment of the present disclosure adopts the second driving mode, corresponding signal timing diagrams are shown in FIG. 7b, FIG. 9a and FIG. 9b. In the tingming diagrams, stv1_1a represents a signal at the frame starting signal terminal STV1_1a, stv1_2a represents a signal at the frame starting signal terminal STV1_2a, stv1_3a represents a signal at the frame starting signal terminal STV1_3a, stv1_4a represents a signal at the frame starting signal terminal STV1_4a, ga1_1 represents a signal input to the the first gate line GA1_1 from the driving output terminal of the first shift register SR1-1a, ga2_1 represents a signal input to the first gate line GA2_1 from the driving output terminal of the first shift register SR2-1a, ga3_1 represents a signal input to the first gate line GA3_1 from the driving output terminal of the first shift register SR3-1a, ga4_1 represents a signal input to the first gate line GA4_1 from the driving output terminal of the first shift register SR4-1a, and ga5_1 represents a signal input to the gate line GA5_1 from the driving output terminal of the first shift register SR5-1a, ga6_1 represents a signal input to the first gate line GA6_1 from the driving output terminal of the first shift register SR6-1a, ga7_1 represents a signal input to the first gate line GA7_1 from the driving output terminal of the first shift register SR7-1a, ga8_1 represents a signal input to the first gate line GA8_1 from the driving output terminal of the first shift register SR8-1a, ga9_1 represents a signal input to the first gate line GA9_1 from the driving output terminal of the first shift register SR9-1a, ga10_1 represents a signal input to the first gate line GA10_1 from the driving output terminal of the first shift register SR10-1a, gal1_1 represents a signal input to the first gate line GA11_1 from the driving output terminal of the first shift register SR11-1a, and ga12_1 represents a signal input to the first gate line GA12_1 from the driving output terminal of the first shift register SR12-1a.

In a case where the second driving mode is adopted, during a display frame, by the control of the first turn-on signal and the fourth turin-on signal, the signal stv1_1a may be applied to the frame starting signal terminal STV1_1a and the signal stv1_4a may be applied to the frame starting signal terminal STV1_4a. The a signal stv1_1a is applied to the frame starting signal terminal STV1_1a, so that the first shift registers in the first cascade group GL1_1a are controlled to output the signals ga1_1, ga2_1 and ga3_1 to the first gate lines GA1_1, GA2_1 and GA3_1 coupled thereto; a turn-off signal stv1_2a is applied to the frame starting signal terminal STV1_2a, so that the first shift registers in the second cascade group GL1_2a are controlled to output turn-off signals ga4_1, ga5_1 and ga6_1 to first gate lines GA4_1, GA5_1 and GA6_1 coupled thereto; a turn-off signal stv1_3a is applied to the frame starting signal terminal STV1_3a, so that the first shift registers in the third cascade group GL1_3a are controlled to output turn-off signals ga7_1, ga8_1 and ga9_1 to the first gate lines GA7_1, GA8_1 and GA9_1 coupled thereto; the signal stv1_4a is applied to the frame starting signal terminal STV1_4a, so that the first shift register in the fourth cascade group GL1_4a are controlled to output the signals ga10_1, ga11_1 and ga12_1 to the first gate lines GA10_1, GA11_1 and GA12_1 coupled thereto, therefore, the first image region TX1 and the fourth image region TX4 are refreshed without refreshing the second image region TX2 and the third image region TX3.

Furthermore, stv2_1a represents a signal at the frame starting signal terminal STV2_1a, stv2_2a represents a signal at the frame starting signal terminal STV2_2a, stv2_3a represents a signal at the frame starting signal terminal STV2_3a, stv2_4a represents a signal at the frame starting signal terminal STV2_4a, ga1_2 represents a signal input to the second gate line GA1_2 from the driving output terminal of the first shift register SR1-1a, ga2_2 represents a signal input to the second gate line GA2_2 from the driving output terminal of the first shift register SR2-1a, ga3_2 represents a signal input to the second gate line GA3_2 from the driving output terminal of the first shift register SR3-1a, ga4_2 represents a signal input to the second gate line GA 52_2 from the driving output terminal of the first shift register SR4-1a, and ga5_2 represents a signal input to the second gate line GA5_2 from the driving output terminal of the first shift register SR5_1a, ga6_2 represents a signal input to the second gate line GA6_2 from the driving output terminal of the first shift register SR6-1a, ga7_2 represents a signal input to the second gate line GA7_2 from the driving output terminal of the first shift register SR7-1a, ga8_2 represents a signal input to the second gate line GA8_2 from the driving output terminal of the first shift register SR8-1a, ga9_2 represents a signal input to the second gate line GA9_2 from the driving output terminal of the first shift register SR9-1a, ga10_2 represents a signal input to the second gate line GA10_2 from the driving output terminal of the first shift register SR10-1a, gal1_2 represents a signal input to the second gate line GA11_2 from the driving output terminal of the first shift register SR11-1a, and ga12_2 represents a signal input to the second gate line GA12_2 from the driving output terminal of the first shift register SR12-1a.

In a case where the second driving mode is adopted, during a display frame, by the control of the first turn-on signal and the fourth turn-on signal, the signal stv2_1a is applied to the frame starting signal terminal STV2_1a and the signal stv2_4a is applied to the frame starting signal terminal STV2_4a. The signal stv2_1a is applied to the frame starting signal terminal STV2_1a, so that the first shift registers in the first cascade group GL2_1a are controlled to output the signals ga1_2, ga2_2 and ga3_2 to the second gate lines GA1_2, GA2_2 and GA3_2 coupled thereto; a turn-off signal atv2_2a is applied to the frame starting signal terminal STV2_2a, so that the first shift registers in the second cascade group GL2_2a are controlled to output turn-off signals ga4_2, ga5_2 and ga6_2 to the second gate lines GA4_2, GA5_2 and GA6_2 coupled thereto; a turn-off signal stv2_3a is applied to the frame starting signal terminal STV2_3a, so that the first shift registers in the third cascade group GL2_3a are controlled to output turn-off signals ga7_2, ga8_2 and ga9_2 to the second gate lines GA7_2, GA8_2 and GA9_2 coupled thereto; the signal stv2_4a is applied to the frame starting signal terminal STV2_4a, so that the first shift registers in the fourth cascade group GL2_4a are controlled to output the signals ga10_2, ga11_2 and ga12_2 to the second gate line GA10_2, GA11_2 and GA12_2 coupled thereto, so that the first image region TX1 and the fourth image region TX4 are refreshed without refreshing the second image region TX2 and the third image region TX3.

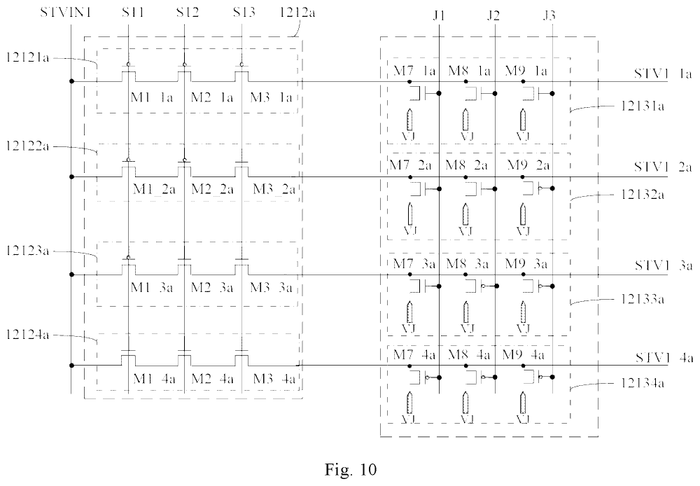

In another embodiment of the present disclosure, as shown in FIG. 10, variations are made to the implementations described in the above embodiment. Only the differences between the present embodiment and the above embodiment will be described below, and the parts that are substantially the same between the present embodiment and the above embodiment will not be described herein again.

In another embodiment of the present disclosure, the target shift register unit further includes: N noise reduction circuits, where the N noise reduction circuits correspond to the N frame trigger selecting sub-circuits and N noise reduction control signals one by one; and an n^{th} noise reduction circuit of the N noise reduction circuits is configured to output, in response to an n^{th} noise reduction control signal of the N noise reduction control signals, a signal at a noise reduction reference signal terminal to a frame starting signal terminal corresponding to the n^{th} cascade group. Therefore, the signal interference at the frame starting signal terminal can be reduced through the noise reduction circuit, and the display effect is improved.

In some implementations, as shown in FIG. 10, the first target shift register unit 121a may further include: four noise reduction circuits (i.e., 12131a, 12132a, 12133a and 12134a). The four noise reduction circuits (i.e., 12131a, 12132a, 12133a and 12134 a) are connected to a noise reduction reference signal terminal VJ.

For example, when an inactive level signal at the frame starting signal terminal is a high level signal, a level signal output by the noise reduction reference signal terminal is a high level signal. When the inactive level signal of the frame starting signal terminal is a low level signal, a level signal output by the noise reduction reference signal terminal is a low level signal.

In some implementations, as shown in FIG. 10, a first noise reduction circuit 12131a of the four noise reduction circuits (i.e., 12131a, 12132a, 12133a and 12134 a) is configured to output, in response to a first noise reduction control signal of the four noise reduction control signals, a signal at the noise reduction reference signal terminal VJ to the frame starting signal terminal STV1_1a corresponding to the first cascade group GL1_1a.

A second noise reduction circuit 12132a of the four noise reduction circuits is configured to output, in response to a second noise reduction control signal of the four noise reduction control signals, the signal at the noise reduction reference signal terminal VJ to the frame starting signal terminal STV1_2a corresponding to the second cascade group GL1_2a.

A third noise reduction circuit 12133a of the four noise reduction circuits is configured to output, in response to a third noise reduction control signal of the four noise reduction control signals, the signal at the noise reduction reference signal terminal VJ to the frame starting signal terminal STV1_3a corresponding to the third cascade group GL1_3a.

A fourth noise reduction circuit 12134a of the four noise reduction circuits is configured to output, in response to a fourth noise reduction control signal of the fourth noise reduction control signals, the signal at the noise reduction reference signal terminal VJ to the frame starting signal terminal STV1_4a corresponding to the fourth cascade group GL1_4a.

In other embodiments of the present disclosure, the display panel further includes: K noise reduction signal lines. The n^{th} noise reduction circuit includes: K noise reduction transistors, where, a first electrode of each of the K noise reduction transistors is coupled to the noise reduction reference signal terminal, and a second electrode of each of the K noise reduction transistors is coupled to a frame starting signal terminal; and a gate of a k^{th} noise reduction transistor in each noise reduction circuit is coupled to a k^{th} noise reduction control signal line of the K noise reduction control signal lines. K is an integer greater than 0, k is greater than or equal to 1 and less than or equal to K, and k is an integer. In some implementations, K may be set to 1, 2, 3, 4, 5, 8 or more, which is not limited herein.

In other embodiments of the present disclosure, at least part of the noise reduction transistors in the noise reduction circuits are of different types.

In some implementations, taking a case where K is equal to 3 as an example, as shown in FIG. 10, the display panel may include three noise reduction control signal lines (e.g., J1, J2 and J3). The four noise reduction circuits (i.e., 12131a, 12132a, 12133a and 12134a) in the first target shift register units 121a each are coupled to three noise reduction control signal lines (e.g., J1, J2 and J3).

In some implementations, taking a case where K is equal to 3 as an example, as shown in FIG. 10, a first noise reduction circuit 12131a of the four noise reduction circuits (i.e., 12131a, 12132a, 12133a and 12134 a) includes: three noise reduction transistors (e.g., M7_1a, M8_1a and M9_1a); where, a gate of a first noise reduction transistor M7_1a of the three noise reduction transistors is coupled to a first noise reduction control signal line J1 of the three noise reduction control signal lines (e.g., J1, J2 and J3), a first electrode of the first noise reduction transistor M7_1a is coupled to the noise reduction reference signal terminal VJ, and a second electrode of the first noise reduction transistor M7_1a is coupled to the frame starting signal terminal STV1_1a corresponding to the first cascade group GL1_1a. A gate of a second noise reduction transistor M8_1a of the three noise reduction transistors is coupled to a second noise reduction control signal line J2 of the three noise reduction control signal lines, a first electrode of the second noise reduction transistor M8_1a of the three noise reduction transistors is coupled to the noise reduction reference signal terminal VJ, and a second electrode of the second noise reduction transistor M8_1a of the three noise reduction transistors is coupled to the frame starting signal terminal STV1_1a corresponding to the first cascade group GL1_1a. A gate of the third noise reduction transistor M9_1a of the three noise reduction transistors is coupled to a third noise reduction control signal line J3 of the three noise reduction control signal lines, a first electrode of the third noise reduction transistor M9_1a of the three noise reduction transistors is coupled to the noise reduction reference signal terminal VJ, and a second electrode of the third noise reduction transistor M9_1a of the three noise reduction transistors is coupled to the frame starting signal terminal STV1_1a corresponding to the first cascade group GL1_1a.

In some implementations, the first noise reduction transistor M7_1a of the three noise reduction transistors (e.g., M7_1a, M8_1a and M9_1a) is an N-type transistor, the second noise reduction transistor M8_1a of the three noise reduction transistors is an N-type transistor, and the third noise reduction transistor M9_1a of the three noise reduction transistors is an N-type transistor.

A second noise reduction circuit 12132a of the four noise reduction circuits (i.e., 12131a, 12132a, 12133a and 12134 a) includes: three noise reduction transistors (e.g., M7_2a, M8_2a and M9_2a); wherein, a gate of a first noise reduction transistor M7_2a of the three noise reduction transistors is coupled to the first noise reduction control signal line J1 of the three noise reduction control signal lines (e.g., J1, J2 and J3), a first electrode of the first noise reduction transistor M7_2a is coupled to the noise reduction reference signal terminal VJ, and a second electrode of the first noise reduction transistor M7_2a is coupled to the frame starting signal terminal STV1_2a corresponding to the second cascade group GL1_2a. A gate of a second noise reduction transistor M8_2a of the three noise reduction transistors is coupled to the second noise reduction control signal line J2 of the three noise reduction control signal lines, a first electrode of the second noise reduction transistor M8_2a of the three noise reduction transistors is coupled to the noise reduction reference signal terminal VJ, and a second electrode of the second noise reduction transistor M8_2a of the three noise reduction transistors is coupled to the frame starting signal terminal STV1_2a corresponding to the second cascade group GL1_2a. A gate of a third noise reduction transistor M9_2a of the three noise reduction transistors is coupled to the third noise reduction control signal line J3 of the three noise reduction control signal lines, a first electrode of the third noise reduction transistor M9_2a of the three noise reduction transistors is coupled to the noise reduction reference signal terminal VJ, and a second electrode of the third noise reduction transistor M9_2a of the three noise reduction transistors is coupled to the frame starting signal terminal STV1_2a corresponding to the second cascade group GL1_2a.

In some implementations, the first noise reduction transistor M7_2a of the three noise reduction transistors (e.g., M7_2a, M8_2a and M9_2a) is an N-type transistor, the second noise reduction transistor M8_2a of the three noise reduction transistors is an N-type transistor, and the third noise reduction transistor M9_2a of the three noise reduction transistors is a P-type transistor.

A third noise reduction circuit 12133a of the four noise reduction circuits (i.e., 12131a, 12132a, 12133a and 12134a) includes: three noise reduction transistors (e.g., M7_3a, M8_3a and M9_3a); where, a gate of a first noise reduction transistor M7_3a of the three noise reduction transistors is coupled to the first noise reduction control signal line J1 of the three noise reduction control signal lines (e.g., J1, J2 and J3), a first electrode of the first noise reduction transistor M7_3a is coupled to the noise reduction reference signal terminal VJ, and a second electrode of the first noise reduction transistor M7_3a is coupled to the frame starting signal terminal STV1_3a corresponding to the third cascade group GL1_3a. A gate of a second noise reduction transistor M8_3a of the three noise reduction transistors is coupled to the second noise reduction control signal line J2 of the three noise reduction control signal lines, a first electrode of the second noise reduction transistor M8_3a of the three noise reduction transistors is coupled to the noise reduction reference signal terminal VJ, and a second electrode of the second noise reduction transistor M8_3a of the three noise reduction transistors is coupled to the frame starting signal terminal STV1_3a corresponding to the third cascade group GL1_3a. A gate of a third noise reduction transistor M9_3a of the three noise reduction transistors is coupled to the third noise reduction control signal line J3 of the three noise reduction control signal lines, a first electrode of the third noise reduction transistor M9_3a of the three noise reduction transistors is coupled to the noise reduction reference signal terminal VJ, and a second electrode of the third noise reduction transistor M9_3a of the third noise reduction transistors is coupled to the frame starting signal terminal STV1_3a corresponding to the third cascade group GL1_3a.

In some implementations, the first noise reduction transistor M7_3a of the three noise reduction transistors (e.g., M7_3a, M8_3a and M9_3a) is an N-type transistor, the second noise reduction transistor M8_3a of the three noise reduction transistors is a P-type transistor, and the third noise reduction transistor M9_3a of the three noise reduction transistors is a P-type transistor.

A fourth noise reduction circuit 12134a of the four noise reduction circuits (i.e., 12131a, 12132a, 12133a and 12134a) includes: three noise reduction transistors (e.g., M7_4a, M8_4a and M9_4a); where, a gate of a first noise reduction transistor M7_4a of the three noise reduction transistors is coupled to the first noise reduction control signal line J1 of the three noise reduction control signal lines (e.g., J1, J2 and J3), a first electrode of the first noise reduction transistor M7_4a is coupled to the noise reduction reference signal terminal VJ, and a second electrode of the first noise reduction transistor M7_4a is coupled to the frame starting signal terminal STV1_4a corresponding to the fourth cascade group GL1_4a. A gate of the second noise reduction transistor M8_4a of the three noise reduction transistors is coupled to the second noise reduction control signal line J2 of the three noise reduction control signal lines, a first electrode of the second noise reduction transistor M8_4a of the three noise reduction transistors is coupled to the noise reduction reference signal terminal VJ, and a second electrode of the second noise reduction transistor M8_4a of the three noise reduction transistors is coupled to the frame starting signal terminal STV1_4a corresponding to the fourth cascade group GL1_4a. A gate of a third noise reduction transistor M9_4a of the three noise reduction transistors is coupled to the third noise reduction control signal line J3 of the three noise reduction control signal lines, a first electrode of the third noise reduction transistor M9_4a of the three noise reduction transistors is coupled to the noise reduction reference signal terminal VJ, and a second electrode of the third noise reduction transistor M9_4a of the three noise reduction transistors is coupled to the frame starting signal terminal STV1_4a corresponding to the fourth cascade group GL1_4a.

In some implementations, the first noise reduction transistor M7_4a of the three noise reduction transistors (e.g., M7_4a, M8_4a and M9_4a) is a P-type transistor, the second noise reduction transistor M8_4a of the three noise reduction transistors is a P-type transistor, and the third noise reduction transistor M9_4a of the three noise reduction transistors is a P-type transistor.

The second target shift register is also provided with a noise reduction circuit, the configuration of which can refer to the above description, which is not described herein again.

Certainly, the types of noise reduction transistors described above are merely illustrative. In practical applications, the type of each noise reduction transistor may be configured according to the level signal received by the gate thereof. For example, in a case where the noise reduction transistor is controlled to be turned on by a low level signal, a P-type transistor may be selected as the noise reduction transistor. In a case where the noise reduction transistor is turned on by a high level signal, an N-type transistor may be selected as the noise reduction transistor.

In some implementations of the present disclosure, the n^{th} noise reduction control signal includes K level signals, and a gate of the k^{th} noise reduction transistor of the K noise reduction transistors is configured to receive a k^{th} level signal of the K level signals; the k^{th} level signal is input through the k^{th} noise reduction control signal line of the K noise reduction control signal lines; K is an integer greater than 0, k is greater than or equal to 1 and less than or equal to K, and k is an integer. In some implementations, K may be set to 1, 2, 3, 4, 5, 8 or more, and is not limited herein.

In some implementations, taking a case where K is equal to 3 as an example, as shown in FIG. 10, each of the four noise reduction control signals includes three level signals, and the gate of the first noise reduction transistor (e.g., M7_1a, M7_2a, M7_3a or M7_4a) of the three noise reduction transistors of each of the four noise reduction circuits (i.e., 12131a, 12132a, 12133a and 12134a) is configured to receive a first level signal of the three level signals; the gate of the second noise reduction transistor (e.g., M8_1a, M8_2a, M8_3a or M8_4a) of the three noise reduction transistors of each of the four noise reduction circuits (i.e., 12131a, 12132a, 12133a and 12134a) is configured to receive a second level signal of the three level signals; a gate of the third noise reduction transistor (e.g., M9_1a, M9_2a, M9_3a or M9_4a) of the three noise reduction transistors of each of the four noise reduction circuits (i.e., 12131a, 12132a, 12133a and 12134a) is configured to receive a third level signal of the three level signals.

The first level signal is inputted through the first noise reduction control signal line J1 of the three noise reduction control signal lines (e.g., J1, J2 and J3), the second level signal is inputted through the second noise reduction control signal line J2 of the three noise reduction control signal lines (e.g., J1, J2 and J3), and the third level signal is inputted through the third noise reduction control signal line J3 of the three noise reduction control signal lines (e.g., J1, J2 and J3).

In other embodiments of the present disclosure, K is equal to M, and the m^{th} first turn-on signal line and the k^{th} noise reduction control signal line transmit signals having the same or opposite phases simultaneously.

For example, as shown in FIG. 10, the first frame trigger selecting sub-circuit 12121a and the first noise reduction circuit 12131a are taken as an example for explanation. The first first turn-on signal line S11 and the first noise reduction control signal line J1 transmit signals having the same phase simultaneously. The second first turn-on signal line S12 and the second noise reduction control signal line J2 transmit signals having the same phase simultaneously. The third first turn-on signal line S13 and the third noise reduction control signal line J3 transmit signals having the same phase simultaneously. In some implementations, a low level signal is represented by “0”, a high level signal is represented by “1”, and when the first turn-on signal is 000, the first first turn-on signal line S11 is input with a low level signal, the second first turn-on signal line S12 is input with a low level signal, and the third first turn-on signal line S13 is input with a low level signal. The first noise reduction control signal is also 000, the first noise reduction control signal line J1 is input with a low level signal, the second noise reduction control signal line J2 is input with a low level signal, and the third noise reduction control signal line J3 is input with a low level signal. The three trigger transistors (i.e., M1_1a, M2_1a and M3_1a) electrically connect the frame trigger input STVIN1 with the frame starting signal terminal STV1_1a corresponding to the first cascade group GL1_1a under the control of three low level signals of the first turn-on signal on the three first turn-on signal lines (i.e., S11, S12 and S13). The three noise reduction transistors (i.e., M7_1a, M8_1a and M9_1 a) are turned off under the control of the three low level signals of the first noise reduction control signal on the three noise reduction control signal lines (e.g., J1, J2 and J3), respectively. The P-type transistor is turned off under the control of a high level signal and turned on under the control of a low level signal. The N-type transistor is turned on under the control of a high level signal and turned off under the control of a low level signal.

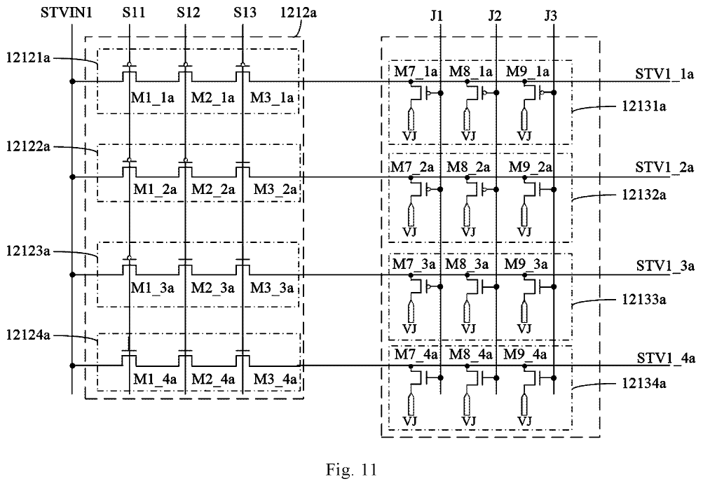

In still another embodiment of the present disclosure, as shown in FIG. 11, variations are made to the implementations in the above-described embodiments. Only the differences between the present embodiment and the above embodiments will be described below, and the parts that are substantially the same between the present embodiment and the above embodiments will be described below will not be described herein again.

In some implementations, as shown in FIG. 11, the first noise reduction transistor M7_1a of the three noise reduction transistors (i.e., M7_1a, M8_1a and M9_1a) of the first noise reduction circuit 12131a of the four noise reduction circuits (i.e., 12131a, 12132a, 12133a and 12134a) is a P-type transistor, the second noise reduction transistor M8_1a of the three noise reduction transistors (i.e., M7_1a, M8_1a and M9_1a) of the first noise reduction circuit 12131a of the four noise reduction circuits (i.e., 12131a, 12132a, 12133a and 12134a) is a P-type transistor, and the third noise reduction transistor M9_1a of the three noise reduction transistors (i.e., M7_1a, M8_1a and M9_1a) of the first noise reduction circuit 12131a of the four noise reduction circuits (i.e., 12131a, 12132a, 12133a and 12134a) is a P-type transistor.

In some implementations, the first noise reduction transistor M7_2a of the three noise reduction transistors (i.e., M7_2a, M8_2a and M9_2a) of the second noise reduction circuit 12132a of the four noise reduction circuits (i.e., 12131a, 12132a, 12133a and 12134a) is a P-type transistor, the second noise reduction transistor M8_2a of the three noise reduction transistors (i.e., M7_2a, M8_2a and M9_2a) of the second noise reduction circuit 12132a of the four noise reduction circuits (i.e., 12131a, 12132a, 12133a and 12134a) is a P-type transistor, and the third noise reduction transistor M9_2a of the three noise reduction transistors (i.e., M7_2a, M8_2a and M9_2a) of the second noise reduction circuit 12132a of the four noise reduction circuits (i.e., 12131a, 12132a, 12133a and 12134a) is an N-type transistor.

In some implementations, the first noise reduction transistor M7_3a of the three noise reduction transistors (i.e., M7_3a, M8_3a and M9_3a) of the third noise reduction circuit 12133a of the four noise reduction circuits (i.e., 12131a, 12132a, 12133a and 12134a) is a P-type transistor, the second noise reduction transistor M8_3a of the three noise reduction transistors (i.e., M7_3a, M8_3a and M9_3a) of the third noise reduction circuit 12133a of the four noise reduction circuits (i.e., 12131a, 12132a, 12133a and 12134a) is an N-type transistor, and the third noise reduction transistor M9_3a of the three noise reduction transistors (i.e., M7_3a, M8_3a and M9_3a) of the third noise reduction circuit 12133a of the four noise reduction circuits (i.e., 12131a, 12132a, 12133a and 12134a) is an N-type transistor.

In some implementations, the first noise reduction transistor M7_4a of the three noise reduction transistors (i.e., M7_4a, M8_4a, M9_4 a) of the fourth noise reduction circuit 12134a of the four noise reduction circuits (i.e., 12131a, 12132a, 12133a and 12134a) is an N-type transistor, the second noise reduction transistor M8_4a of the three noise reduction transistors (i.e., M7_4a, M8_4a, M9_4 a) of the fourth noise reduction circuit 12134a of the four noise reduction circuits (i.e., 12131a, 12132a, 12133a and 12134a) is an N-type transistor, and the third noise reduction transistor M9_4a of the three noise reduction transistors (i.e., M7_4a, M8_4a, M9_4 a) of the fourth noise reduction circuit 12134a of the four noise reduction circuits (i.e., 12131a, 12132a, 12133a and 12134a) is an N-type transistor.

The second target shift register is also provided with a noise reduction circuit, and the configuration of the noise reduction circuit can refer to the above description, which is not described herein again.

Certainly, the types of noise reduction transistors described above are merely illustrative. In practical applications, the type of each noise reduction transistor may be selected according to the level signal received by the gate thereof. For example, in a case where the noise reduction transistor is controlled to be turned on by a low level signal, a P-type transistor may be selected as the noise reduction transistor. In a case where the noise reduction transistor is turned on by a high level signal, an N-type transistor may be selected as the noise reduction transistor.

In some implementations, as shown in FIG. 11, the first frame trigger selecting sub-circuit 12121a and the first noise reduction circuit 12131a are taken as an example for explanation. The first first turn-on signal line S11 and the first noise reduction control signal line J1 simultaneously transmit signals with opposite phases (the first first turn-on signal line S11 transmits a signal, and at the same time, the first noise reduction control signal line J1 transmit a singl having an opposite phase to that of the signal transmitted by the first first turn-on signal line S11). The second first turn-on signal line S12 and the second noise reduction control signal line J2 simultaneously transmit signals with opposite phases (the second first turn-on signal line S12 transmits a signal, and at the same time, the second noise reduction control signal line J2 transmits a signal having an opposite phase to that of the signal transmitted by the second first turn-on signal line S12). The third first turn-on signal line S13 and the third noise reduction control signal line J3 simultaneously transmit signals with opposite phases (the third first turn-on signal line S13 transmits a signal, and at the same time, the third noise reduction control signal line J3 transmit a signal having an opposite phase to that of the signal transmitted by the third first turn-on signal line S13). In some implementations, a low level signal is represented by “0”, a high level signal is represented by “1”, and in a case where the first turn-on signal is 000, the first first turn-on signal line S11 is input with a low level signal, the second first turn-on signal line S12 is input with a low level signal, and the third first turn-on signal line S13 is input with a low level signal. The first noise reduction control signal is 111, the first noise reduction control signal line J1 is input with a high level signal, the second noise reduction control signal line J2 is input with a high level signal, and the third noise reduction control signal line J3 is input with a high level signal. The three trigger transistors (i.e., M1_1a, M2_1a and M3_1a) electrically connect, respectively under the control of the three low level signals of the first turn-on signal on the three first turn-on signal lines (i.e., S11, S12 and S13), the frame trigger input STVIN1 with the frame starting signal terminal STV1_1a corresponding to the first cascade group GL1_1a. The three noise reduction transistors (i.e., M7_1a, M8_1a and M9_1a) are turned off under the control of the three high level signals of the first noise reduction control signal on the three noise reduction control signal lines (e.g., J1, J2 and J3).

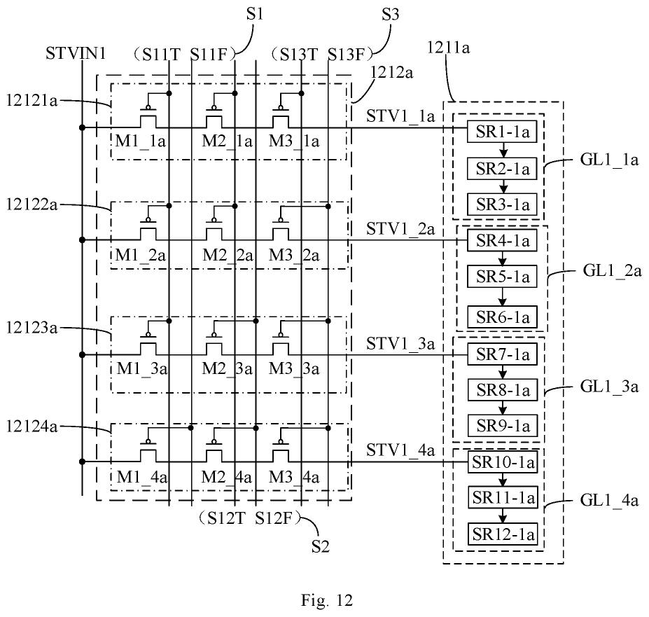

In still another embodiment of the present disclosure, as shown in FIG. 12, variations are made to the implementations in the above-described embodiments. Only the differences between the present embodiment and the above embodiments will be described below, and the parts that are substantially the same between the present embodiment and the above embodiments will not be described herein again.

In still another embodiment of the present disclosure, the types of the trigger transistors in all the frame trigger selecting sub-circuits are the same.

In some implementations, as shown in FIG. 12, the types of the trigger transistors in all the frame trigger selecting sub-circuits (i.e., 12121a, 12122a, 12123a and 12124a) are the same, for example, are all P-type transistors. Certainly, the types of trigger transistors described above are merely illustrative. In practical applications, the type of each trigger transistor may be selected according to the level signal received by the gate thereof. For example, in a case where the trigger transistor is controlled to be turned on by a low level signal, a P-type transistor may be selected as the trigger transistor. In a case where the trigger transistor is turned on by a high level signal, an N-type transistor may be selected as the trigger transistor.

In still another embodiment of the present disclosure, the display panel further includes: M signal line groups, where, each of the M signal line groups includes a second turn-on signal line and a third turn-on signal line; the second turn-on signal line and the third turn-on signal line in the same signal line group simultaneously transmit signals with opposite phases; an m^{th} trigger transistor in each frame trigger selecting sub-circuit corresponds to an m^{th} signal line group of the M signal line groups, gates of the m^{th} trigger transistors in part of the frame trigger selecting sub-circuits are coupled to the second turn-on signal line in the m^{th} signal line group, and gates of the m^{th} trigger transistors in the rest of the frame trigger selecting sub-circuits are coupled to the third turn-on signal line in the m^{th} signal line group.

In some implementations, as shown in FIG. 12, taking a case where M is equal to 3 as an example, the display panel further includes: three signal line groups (e.g., S1, S2 and S3); each of the three signal line groups includes second turn-on signal lines (e.g., S11T, S12T and S13T) and third turn-on signal lines (e.g., S11F, S12F and S13F). The second turn-on signal line S11T and the third turn-on signal line S11F in the first signal line group S1 simultaneously transmit signals having opposite phases. The second turn-on signal line S12T and the third turn-on signal line S12F in the second signal line group S2 simultaneously transmit signals having opposite phases. The second turn-on signal line S13T and the third turn-on signal line S13F in the third signal line group S3 simultaneously transmit signals having opposite phases. For example, a low level signal is represented by “0”, and a high level signal is represented by “1”. Taking the first frame trigger selecting sub-circuit 1212a as an example, if the first turn-on signal is 000, the second turn-on signal line S11T in the first signal line group S1 is input with a low level signal, and the third turn-on signal line S11F in the first signal line group S1 is input with a high level signal. The second turn-on signal line S12T in the second signal line group S2 is input with a low level signal, and the third turn-on signal line S12F in the second signal line group S2 is input with a high level signal. The second turn-on signal line S13T in the third signal line group S3 is input with a low level signal, and the third turn-on signal line S13F in the third signal line group S3 is input with a high level signal.

In some implementations, the first trigger transistor M1_1a in the first frame trigger selecting sub-circuit 12121a of the frame trigger selecting sub-circuits (i.e., 12121a, 12122a, 12123a and 12124a) corresponds to the first signal line group S1 of the three signal line groups (i.e., S1, S2 and S3), the second trigger transistor M2_1a in the first frame trigger selecting sub-circuit 12121a of the frame trigger selecting sub-circuits (i.e., 12121a, 12122a, 12123a and 12124a) corresponds to the second signal line group S2 of the three signal line groups (i.e., S1, S2 and S3), and the third trigger transistor M3_1a in the first frame trigger selecting sub-circuit 12121a of the frame trigger selecting sub-circuits (i.e., 12121a, 12122a, 12123a and 12124a) corresponds to the third signal line group S3 of the three signal line groups (i.e., S1, S2 and S3).

In some implementations, the first trigger transistor M1_2a in the second frame trigger selecting sub-circuit 12122a of the frame trigger selecting sub-circuits (i.e., 12121a, 12122a, 12123a and 12124a) corresponds to the first signal line group S1 of the three signal line groups (i.e., S1, S2 and S3), the second trigger transistor M2_2a in the second frame trigger selecting sub-circuit 12122a of the frame trigger selecting sub-circuits (i.e., 12121a, 12122a, 12123a and 12124a) corresponds to the second signal line group S2 of the three signal line groups (i.e., S1, S2 and S3), and the third trigger transistor M3_2a in the second frame trigger selecting sub-circuit 12122a of the frame trigger selecting sub-circuits (i.e., 12121a, 12122a, 12123a and 12124a) corresponds to the third signal line group S3 of the three signal line groups (i.e., S1, S2 and S3).

In some implementations, the first trigger transistor M1_3a in the third frame trigger selecting sub-circuit 12123a of the frame trigger selecting sub-circuits (i.e., 12121a, 12122a, 12123a and 12124a) corresponds to the first signal line group S1 of the three signal line groups (i.e., S1, S2 and S3), the second trigger transistor M2_3a in the third frame trigger selecting sub-circuit 12123a of the frame trigger selecting sub-circuits (i.e., 12121a, 12122a, 12123a and 12124a) corresponds to the first signal line group S2 of the three signal line groups (i.e., S1, S2 and S3), and the third trigger transistor M3_3a in the third frame trigger selecting sub-circuit 12123a of the frame trigger selecting sub-circuits (i.e., 12121a, 12122a, 12123a and 12124a) corresponds to the third signal line group S3 of the three signal line groups (i.e., S1, S2 and S3).

In some implementations, the first trigger transistor M1_4a in the fourth frame trigger selecting sub-circuit 12124a of the frame trigger selecting sub-circuits (i.e., 12121a, 12122a, 12123a and 12124a) corresponds to the first signal line group S1 of the three signal line groups (i.e., S1, S2 and S3), the second trigger transistor M2_4a in the fourth frame trigger selecting sub-circuit 12124a of the frame trigger selecting sub-circuits (i.e., 12121a, 12122a, 12123a and 12124a) corresponds to the second signal line group S2 in the three signal line groups (i.e., S1, S2 and S3), and the third trigger transistor M3_4a in the fourth frame trigger selecting sub-circuit 12124a of the frame trigger selecting sub-circuits (i.e., 12121a, 12122a, 12123a and 12124a) corresponds to the third signal line group S3 in the three signal line groups (i.e., S1, S2 and S3).

In some implementations, the gate of the first trigger transistor M1_1a in the first frame trigger selecting sub-circuit 12121a of the frame trigger selecting sub-circuits (i.e., 12121a, 12122a, 12123a and 12124a) is coupled to the second turn-on signal line S11T in the first signal line group S1 of the three signal line groups (i.e., S1, S2 and S3), the gate of the second trigger transistor M2_1a in the first frame trigger selecting sub-circuit 12121a of the frame trigger selecting sub-circuits (i.e., 12121a, 12122a, 12123a and 12124a) is coupled to the second turn-on signal line S12T in the second signal line group S2 of the three signal line groups (i.e., S1, S2 and S3), and the gate of the third trigger transistor M3_1a in the first frame trigger selecting sub-circuit 12121a of the frame trigger selecting sub-circuits (i.e., 12121a, 12122a, 12123a and 12124a) is coupled to the second turn-on signal line S13T in the third signal line group S3 of the three signal line groups (i.e., S1, S2 and S3).

In some implementations, the gate of the first trigger transistor M1_2a in the second frame trigger selecting sub-circuit 12122a of the frame trigger selecting sub-circuit (i.e., 12121a, 12122a, 12123a and 12124a) is coupled to the second turn-on signal line S11T in the first signal line group S1 of the three signal line groups (i.e., S1, S2 and S3), the gate of the second trigger transistor M2_2a in the second frame trigger selecting sub-circuit 12122a of the frame trigger selecting sub-circuit (i.e., 12121a, 12122a, 12123a and 12124a) is coupled to the second turn-on signal line S12T in the second signal line group S2 of the three signal line groups (i.e., S1, S2 and S3), and the gate of the third trigger transistor M3_2a in the second frame trigger selecting sub-circuit 12122a of the frame trigger selecting sub-circuit (i.e., 12121a, 12122a, 12123a and 12124a) is coupled to the third turn-on signal line S13F of the third signal line group S3 in the three signal line groups (i.e., S1, S2 and S3).

In some implementations, the gate of the first trigger transistor M1_3a in the third frame trigger selecting sub-circuit 12123a of the frame trigger selecting sub-circuits (i.e., 12121a, 12122a, 12123a and 12124a) is coupled to the second turn-on signal line S11T in the first signal line group S1 of the three signal line groups (i.e., S1, S2 and S3), the gate of the second trigger transistor M2_3a in the third frame trigger selecting sub-circuit 12123a of the frame trigger selecting sub-circuits (i.e., 12121a, 12122a, 12123a and 12124a) is coupled to the third turn-on signal line S12F in the second signal line group S2 of the three signal line groups (i.e., S1, S2 and S3), and the gate of the third trigger transistor M3_3a in the third frame trigger selecting sub-circuit 12123a of the frame trigger selecting sub-circuits (i.e., 12121a, 12122a, 12123a and 12124a) is coupled to the third turn-on signal line S13F in the third signal line group S3 of the three signal line groups (i.e., S1, S2 and S3).

In some implementations, the gate of the first trigger transistor M1_4a in the first frame trigger selecting sub-circuit 12124a of the frame trigger selecting sub-circuits (i.e., 12121a, 12122a, 12123a and 12124a) is coupled to the third turn-on signal line S11F in the first signal line group S1 of the three signal line groups (i.e., S1, S2 and S3), the gate of the second trigger transistor M2_4a in the first frame trigger selecting sub-circuit 12124a of the frame trigger selecting sub-circuits (i.e., 12121a, 12122a, 12123a and 12124a) is coupled to the third turn-on signal line S12F in the second signal line group S2 of the three signal line groups (i.e., S1, S2 and S3), and the gate of the third trigger transistor M3_4a in the first frame trigger selecting sub-circuit 12124a of the frame trigger selecting sub-circuits (i.e., 12121a, 12122a, 12123a and 12124a) is coupled to the third turn-on signal line S13F in the third signal line group S3 of the three signal line groups (i.e., S1, S2 and S3).

Based on the same creative concept, an embodiment of the present disclosure further provides a display apparatus, which includes the above described display panel provided by the embodiments of the present disclosure. The principle of the display apparatus for solving the problems is similar to that of the display panel, so the embodiment of the display apparatus may refer to the embodiments of the display panel, and repeated description thereof is omitted here.

In a specific implementation, the display device may be any product or component with a display function, such as a mobile phone, a tablet computer, a television, a display, a notebook computer, a digital photo frame, a navigator and the like. Other essential components of the display device are understood by those skilled in the art, and are not described herein nor should they be construed as limiting the present disclosure.

As will be appreciated by those skilled in the art, the embodiments of the present disclosure may be provided as a method, a system, or a computer program product. Accordingly, the present disclosure may take the form of an embodiment of a complete hardware, an embodiment of a complete software or an embodiment combining software and hardware aspects. Furthermore, the present disclosure may take the form of a computer program product embodied on one or more computer-usable storage medium (including, but not limited to, disk storage, CD-ROM, optical storage, and the like) having computer-usable program code embodied therein.

The present disclosure is described with reference to flowcharts and/or block diagrams of the methods, the apparatus (systems), and the computer program product according to the present disclosure. It will be understood that each flow and/or block of the flowcharts and/or block diagrams, and combinations of flows and/or blocks in the flowcharts and/or block diagrams, can be implemented by computer program instructions. These computer program instructions may be provided to a processor of a general purpose computer, special purpose computer, embedded processor, or other programmable data processing apparatus to produce a machine, such that the instructions, which are executed by the processor of the computer or other programmable data processing apparatus, create means for implementing the functions specified in one or more flows in the flowchart and/or one or more blocks in the block diagram.

These computer program instructions may alternatively be stored in a computer-readable memory that can direct a computer or other programmable data processing apparatus to operate in a specific manner, such that the instructions stored in the computer-readable memory produce a product including an instruction mean which implement the function specified in one or more flows in the flowchart and/or one or more blocks in the block diagram.

These computer program instructions may alternatively be loaded onto a computer or other programmable data processing apparatus to cause a series of operation steps to be performed on the computer or other programmable apparatus to produce a computer implemented process such that the instructions which are executed on the computer or other programmable apparatus provide steps for implementing the functions specified in one or more flows in the flowchart and/or one or more blocks in the block diagram.

Although preferred embodiments of the present disclosure have been described, those skilled in the art may make additional changes and modifications to these embodiments once they have knowledge of the basic creative concepts. Therefore, the attached claims are intended to be interpreted as including the preferred embodiments and all changes and modifications falling within the scope of the present disclosure.

It will be apparent to those skilled in the art that various changes and modifications may be made in the present disclosure without departing from the spirit and scope of the present disclosure. Thus, if such changes and modifications of the present disclosure fall within the scope of the claims of the present disclosure and their equivalents, the present disclosure is intended to include such modifications and changes as well.

1. A display panel, comprising:
a plurality of gate lines; and
a plurality of shift register units, wherein a target shift register unit of the plurality of shift register units comprises: a frame trigger selecting circuit and a gate driving circuit; the gate driving circuit comprises a plurality of first shift registers, a driving output terminal of each first shift register is coupled to at least one of the gate lines, the plurality of first shift registers are divided into N cascade groups, the first shift registers in each cascade group are cascaded, and different cascade groups are coupled to different frame starting signal terminals; N is an integer greater than 1, wherein
the frame trigger selecting circuit is coupled to a frame trigger input terminal and the frame starting signal terminals corresponding to the N cascade groups; the frame trigger selecting circuit is configured to output, in response to an n^{th} turn-on signal of N turn-on signals corresponds to an n^{th} cascade group of the N cascade groups, a starting signal input to the frame trigger input terminal to a frame starting signal terminal corresponding to the n^{th} cascade group; n is more than or equal to 1 and less than or equal to N, and n is an integer; and
the n^{th} cascade group is configure to scan the gate lines coupled thereto line by line after the frame starting signal terminal corresponding thereto receives the starting signal.

2. The display panel of claim 1, wherein the frame trigger selecting circuit comprises: N frame trigger selecting sub-circuits, the N frame trigger selecting sub-circuits corresponding to the N cascade groups and the N turn-on signals one by one;
input terminals of the N frame trigger selecting sub-circuits are coupled to the frame trigger input terminal, and an output terminal of an n^{th} frame trigger selecting sub-circuit of the N frame trigger selecting sub-circuits is coupled to the frame starting signal terminal corresponding to the n^{th} cascade group; and
the n^{th} frame trigger selecting sub-circuit is configured to output, in response to the n^{th} turn-on signal, the starting signal input to the frame trigger input terminal to the frame starting signal terminal corresponding to the n^{th} cascade group.

3. The display panel of claim 2, wherein the n^{th} frame trigger selecting sub-circuit comprises: M trigger transistors, a first electrode of a first trigger transistor of the M trigger transistors is coupled to the frame trigger input terminal, a second electrode of a former one of every two adjacent trigger transistors is coupled to a first electrode of a latter one of the two adjacent trigger transistors, and a second electrode of a last trigger transistor of the M trigger transistors is coupled to the frame starting signal terminal corresponding to the n^{th} cascade group;
the n turn-on signal comprises M level signals, and a gate of an m^{th} trigger transistor of the M trigger transistors is configured to receive an m^{th} level signal of the M level signals; and
M is an integer greater than 0, m is greater than or equal to 1 and less than or equal to M, and m is an integer.

4. The display panel of claim 3, wherein the trigger transistors in at least part of the frame trigger selecting sub-circuits are of different types;
the display panel further comprises: M first turn-on signal lines, the m^{th} level signal is input through an m^{th} first turn-on signal line of the M first turn-on signal lines; and
the gate of the m^{th} trigger transistor in each frame trigger selecting sub-circuit is coupled to the m^{th} first turn-on signal line of the M first turn-on signal lines.

5. The display panel of claim 3, wherein the trigger transistors in all of the frame trigger selecting sub-circuits are of the same type;
the display panel further comprises: M signal line groups, each of the M signal line groups comprises a second turn-on signal line and a third turn-on signal line, the second turn-on signal line and the third turn-on signal line in each signal line group simultaneously transmit signals with opposite phases;
the m^{th} trigger transistor in each frame trigger selecting sub-circuit corresponds to an m^{th} signal line group of the M signal line groups, and the gates of the m^{th} trigger transistors in part of the frame trigger selecting sub-circuits are coupled to the second turn-on signal line in the m^{th} signal line group, and the gates of the m^{th} trigger transistors in the rest of the frame trigger selecting sub-circuits are coupled to the third turn-on signal line in the m^{th} signal line group.

6. The display panel of claim 2, wherein the target shift register unit further comprises: N noise reduction circuits, the N noise reduction circuits corresponding to the N frame trigger selecting sub-circuits and N noise reduction control signals one by one; and
an n^{th} noise reduction circuit of the N noise reduction circuits is configured to output, in response to an n^{th} noise reduction control signal of the N noise reduction control signals, a signal at a noise reduction reference signal terminal to the frame starting signal terminal corresponding to the n^{th} cascade group.

7. The display panel of claim 6, wherein the n^{th} noise reduction circuit comprises: K noise reduction transistors, a first electrode of each of the K noise reduction transistors is coupled to the noise reduction reference signal terminal, and a second electrode of each of the K noise reduction transistors is coupled to the frame starting signal terminal;
an n^{th} noise reduction control signal comprises K level signals, and the gate of a k^{th} noise reduction transistor of the K noise reduction transistors is configured to receive a k^{th} level signal of the K level signals; and
K is an integer greater than 0, k is greater than or equal to 1 and less than or equal to K, and k is an integer.

8. The display panel of claim 7, wherein the noise reduction transistors in at least part of the noise reduction circuits are different in type;
the display panel further comprises: K noise reduction control signal lines; the k^{th} level signal is input through a k^{th} noise reduction control signal line of the K noise reduction control signal lines; and
the gate of the k^{th} noise reduction transistor in each noise reduction circuit is coupled to the k^{th} noise reduction control signal line of the K noise reduction control signal lines.

9. The display panel of claim 8, wherein K is equal to M, and the m^{th} first turn-on signal line and k^{th} noise reduction control signal line simultaneously transmit signals having the same or opposite phases.

10. The display panel of claim 1, wherein the plurality of gate lines comprises a plurality of first gate lines; the target shift register unit comprises a first target shift register unit; a driving output terminal of each first shift register in the first target shift register unit is coupled to at least one of the first gate lines; and
the display panel comprises a pixel circuit, the pixel circuit comprises a turn-on control transistor; one of the first gate lines is coupled to a gate of the turn-on control transistor, and is configured to drive the turn-on control transistor.

11. The display panel of claim 1, wherein the plurality of gate lines comprises a plurality of second gate lines; the target shift register unit comprises a second target shift register unit; a driving output terminal of each first shift register in the second target shift register unit is coupled to at least one of the second gate lines; and
the display panel comprises a pixel circuit, the pixel circuit comprises a data writing transistor; one of the second gate lines is coupled to a gate of the data writing transistor, and configured to drive the data writing transistor.

12. The display panel of claim 1, wherein each first shift register in the target shift register unit comprises a left first shift register and a right first shift register coupled to the gate line at two sides of the gate line, respectively; and
the left first shift register and the right first shift register are configured to simultaneously drive the gate line coupled thereto.

13. The display panel of claim 1, wherein the display panel further comprises: a plurality of light emission control signal lines;
the plurality of shift register units further comprise: a light emission control circuit; the light emission control circuit comprises a plurality of second shift registers, and a driving output terminal of each second shift register is coupled to at least one of the light emission control signal lines; and
the display panel comprises a pixel circuit; the pixel circuit comprises a first light emission control transistor; the light emission control signal line is coupled to a gate of the first light emission control transistor, and is configured to drive the first light emission control transistor.

14. The display panel of claim 1, wherein the display panel further comprises: a plurality of reset control signal lines;
the plurality of shift register units further comprise: a reset control circuit; the reset control circuit comprises a plurality of third shift registers, and a driving output terminal of each third shift register is coupled to at least one of the reset control signal lines; and
the display panel comprises a pixel circuit; the pixel circuit comprises an anode reset transistor; the reset control signal line is coupled to a gate of the anode reset transistor and is configured to drive the anode reset transistor.

15. A display apparatus, comprising the display panel of claim 1.

16. A method for driving the display panel of claim 1, comprising:
in response to that a first driving mode is adopted, during a display frame, the N turn-on signals are sequentially applied to the frame trigger selecting circuit, then the N cascade groups respectively receive the starting signal through frame starting signal terminals corresponding thereto to control the cascade groups to operate in sequence and the shift registers in each cascade group scans the gate lines coupled thereto line by line, and the plurality of gate lines are scanned line by line; and
in response to that a second driving mode is adopted, during a display frame, a turn-on signal corresponding to a specified cascade group is applied to the frame trigger selecting circuit, then the specified cascade group receives the starting signal through a frame starting signal terminal corresponding thereto to control the shift registers in the specified cascade group to scan the gate lines coupled thereto line by line.

17. The display panel of claim 10, wherein the plurality of gate lines comprises a plurality of second gate lines; the target shift register unit comprises a second target shift register unit; a driving output terminal of each first shift register in the second target shift register unit is coupled to at least one of the second gate lines; and
the display panel comprises a pixel circuit, the pixel circuit comprises a data writing transistor; one of the second gate lines is coupled to a gate of the data writing transistor, and configured to drive the data writing transistor.

18. The display panel of claim 17, wherein each first shift register in the target shift register unit comprises a left first shift register and a right first shift register coupled to the gate line at two sides of the gate line, respectively; and
the left first shift register and the right first shift register are configured to simultaneously drive the gate line coupled thereto.

19. The display panel of claim 18, wherein the display panel further comprises: a plurality of light emission control signal lines;
the plurality of shift register units further comprise: a light emission control circuit; the light emission control circuit comprises a plurality of second shift registers, and a driving output terminal of each second shift register is coupled to at least one of the light emission control signal lines; and
the display panel comprises a pixel circuit; the pixel circuit comprises a first light emission control transistor; the light emission control signal line is coupled to a gate of the first light emission control transistor, and is configured to drive the first light emission control transistor.

20. The display panel of claim 19, wherein the display panel further comprises: a plurality of reset control signal lines;
the plurality of shift register units further comprise: a reset control circuit; the reset control circuit comprises a plurality of third shift registers, and a driving output terminal of each third shift register is coupled to at least one of the reset control signal lines; and
the display panel comprises a pixel circuit; the pixel circuit comprises an anode reset transistor; the reset control signal line is coupled to a gate of the anode reset transistor and is configured to drive the anode reset transistor.
